(19) United States
(12) Patent Application Publication
(10) Pub. No.: US 2023/0023923 A1
(43) Pub. Date: Jan. 26, 2023

(54) Alkyl-Demethylation Processes and Catalyst Compositions Therefor

(71) Applicant: ExxonMobil Chemical Patents Inc., Baytown, TX (US)

(72) Inventors: Chuansheng Bai, Phillipsburg, NJ (US); Ali A. Kheir, Houston, TX (US); Eric D. Metzger, Houston, TX (US); Christian A. Diaz Urrutia, Auderghem (BE); Meha Rungta, Houston, TX (US); Umar Aslam, Houston, TX (US)

(21) Appl. No.: 17/781,068

(22) PCT Filed: Dec. 1, 2020
(86) PCT No.: PCT/US2020/062672

§ 371 Date: May 31, 2022

Related U.S. Application Data
(60) Provisional application No. 62/950,395, filed on Dec. 19, 2019.

(51) Int. Cl. B01J 21/10; B01J 23/50; B01J 35/10; B01J 23/46; B01J 23/00; B01J 37/08; B01J 37/02; C10G 47/10

(52) U.S. Cl. CPC B01J 21/10; B01J 23/50; B01J 35/1019; B01J 23/464; B01J 23/005; B01J 37/088; B01J 37/0207; C10G 47/10; C10G 2300/1096; C10G 2400/30

(57) ABSTRACT

Disclosed are catalyst compositions comprising two or more metal elements with high performances for selective alkyl-demethylation of C2+-hydrocarbyl-substituted aromatics, processes for making such catalyst compositions, and alkyl-demethylation processes using same. Also disclosed are preferred processes for making alkyl-demethylation catalyst compositions including a high-temperature calcination step, and preferred alkyl-demethylation processes having a high H₂/HC molar ratio.

### CROSS-REFERENCE OF RELATED APPLICATION

This application claims the benefit of and priority to U.S. Provisional Application No. 62/950,395, filed Dec. 19, 2019, the disclosure of which is incorporated herein by reference.

### FIELD

This disclosure relates to processes and catalyst compositions for converting C2+-substituted aromatic hydrocarbons into C1-substituted aromatic hydrocarbons, and processes for making such catalyst compositions. Such processes and catalyst compositions may be useful for producing, for example, xylenes, trimethylbenzenes, and the like from heavier aromatic compounds bearing a C2+-alkyl substitute and/or an aliphatic ring annelated to an aromatic ring of the aromatic compound.

### BACKGROUND

Large quantities of p-xylene and o-xylene are consumed worldwide every year. Para-xylene (“p-xylene”) is an important industrial commodity chemical for making terephthalic acid, which is used for making large quantities of polyester fibers. Ortho-xylene (“o-xylene”) is another important industrial commodity chemical for making phthalic acid, which may be used for making plasticizers and other industrial materials. In addition, xylene isomers represent a high-value fuel component in comparison to heavier aromatic compounds, such as those bearing a C2+-alkyl substitute and/or an aliphatic ring annelated to an aromatic ring.

The high demand for xylene isomers has led to the advancement of many technologies for their large-scale fabrication. o-Xylene and p-xylene are often present in C8 aromatic hydrocarbon mixtures additionally comprising meta-xylene and ethylbenzene at various quantities. Separation of p-xylene from such C8 aromatic hydrocarbon mixtures can often be realized through crystallization and adsorption chromatography technologies, for example. The residual filtrate from crystallization-based separation and the raffinate from the adsorption chromatography-based separation (collectively the “raffinate”) are depleted (lean) in p-xylene and rich in m-xylene and o-xylene. In conventional processes, the raffinate may then be isomerized by using an isomerization catalyst to convert a portion of the o- and m-xylenes into p-xylene in a xylenes loop, from which additional p-xylene may be separated.

In a petrochemical plant, a major source of C8 aromatic hydrocarbons is a C6+ hydrocarbon reformate stream produced from a heavy naphtha reforming reactor (“reformer”). In the presence of a reforming catalyst under reforming conditions, paraffins and aromatic hydrocarbons contained in a heavy naphtha feed undergo various complex chemical reactions, such as isomerization, dehydrogenation, dehydrocyclization, aromatization, and the like, to yield a reforming mixture comprising additional branched paraffins, aromatic hydrocarbons, and hydrogen. A C6+ hydrocarbon reformate stream separated from the reforming mixture may comprise benzene, toluene, C8 aromatics, and C9+ aromatics. The C8 aromatics of the C6+ hydrocarbon reformate stream typically comprise, in addition to the xylenes, ethylbenzene at a substantial quantity. The C9+ aromatics of the C6+ hydrocarbon reformate stream typically comprise, in addition to aromatic hydrocarbons comprising only methyl substitutes attached to the aromatic ring therein (e.g., trimethylbenzenes and tetramethylbenzenes), aromatic hydrocarbons comprising at least one C2+ alkyl group (e.g., ethylmethylbenzenes, diethylbenzenes, C3-alkylbenzenes, and the like) and/or aromatic hydrocarbons comprising an aliphatic ring annelated to the aromatic ring (e.g., indane, methylindanes, tetralin, methyltetralins, and the like).

As a result of the foregoing, ethylbenzene and C9+ aromatic hydrocarbons are often present in significant quantities in raffinate and similar hydrocarbon sources, such as steam-cracked naphtha (SCN). SCN streams are oftentimes not considered to be economically viable source materials for producing xylenes due to the high concentrations of ethylbenzene and indane therein. Even in the case of raffinate, strategies for processing the ethylbenzene and indane are usually employed to make this xylenes source material more economically viable and to mitigate other issues during xylenes production. Direct conversion of ethylbenzene and C9+ aromatic hydrocarbons into xylenes via isomerization is often impractical, and a more common strategy to prevent ethylbenzene accumulation in the xylenes loop is to conduct the raffinate isomerization under vapor-phase conditions in the presence of an additional catalyst effective to de-ethylate ethylbenzene to form benzene. Vapor-phase isomerization of this type is energy intensive, however, and the ethylbenzene is not converted into value products, such as xylenes.

To increase the production of xylenes, the C9+ aromatic hydrocarbons in the C6+ hydrocarbon reformate stream can be separated and undergo transalkylation with benzene and/or toluene. In the presence of a suitable transalkylation catalyst under transalkylation conditions, the C9+ aromatic hydrocarbons may exchange methyl groups with benzene and/or toluene to produce additional xylenes from the original source material. Transalkylation usually occurs in under vapor-phase conditions and is likewise rather energy intensive. De-alkylation of at least some of the C9+ aromatic hydrocarbons may occur under the vapor-phase conditions in the presence of a suitable dealkylation catalyst to produce additional benzene and/or toluene in situ during transalkylation, if desired.

As such, there remains a need for more efficient processing of alkylated aromatic hydrocarbons, such as those bearing a C2+-alkyl substitute and/or an aliphatic ring annelated to an aromatic ring, into xylenes and similar value aromatic products bearing methyl substitution upon the aromatic ring. In particular, there remains a need for direct conversion of C8 aromatic hydrocarbons (ethylbenzene) and C9+ aromatic hydrocarbons into aromatic compounds bearing only methyl substitutes, such as xylenes, or a substantial majority of methyl substitutes. Heretofore, direct partial dealkylation of aromatic hydrocarbons bearing one or more alkyl substitutes, particularly ethyl substitutes, larger alkyl substitutes and annelated aliphatic rings, often results in excessive amounts of complete dealkylation and/or aromatic ring loss through hydrogenation and/or ring rupture, thereby resulting in ineffective utilization of the initial hydrocarbon feed. This disclosure rectifies this existing deficiency and provides other advantages as well.

### SUMMARY

Alkyl-demethylation processes and catalyst compositions effective therefor, particularly those comprising two or more metal elements in Groups 7 to 15, can be used to convert C2+-hydrocarbyl-substituted aromatic hydrocarbons with high selectivity into alkyl-demethylated aromatic hydrocarbons, particularly methylated aromatic hydrocarbons. A relatively high calcination temperature of the mixture oxide support and metal source material was found conducive to the performance of the catalyst composition for alkyl-demethylation. Alkyl-demethylation can be beneficially conducted at a relatively high H₂/hydrocarbon molar ratio. The alkyl-demethylation processes and catalyst compositions disclosed herein may afford one or more advantages over conventional techniques for processing aromatic hydrocarbon streams such as (i) improved energy efficiency; (ii) increased production of value aromatic products, such as xylenes; (iii) improved utilization of an aromatic hydrocarbon feed; and (iv) simplified process logistics and equipment.

In a first aspect, this disclosure relates to a catalyst composition for selective alkyl-demethylation of a C2+-hydrocarbyl-substituted aromatic hydrocarbon, the catalyst composition comprising: an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and combinations and mixtures of two or more thereof; a first metal element M1 dispersed upon the oxide support material, wherein M1 is selected from Groups 7, 8, 9, and 10 elements, and combinations thereof; and an optional second metal element M2 dispersed upon the oxide support material, wherein M2 is selected from groups 11, 12, 13, and 14 elements excluding A1, and combinations thereof, wherein M2 is present at least where M1 is a single metal element.

In a second aspect, this disclosure provides process for converting a C2+-hydrocarbyl-substituted aromatic hydrocarbon, the process comprising: (A) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and (B) contacting the C6+ aromatic hydrocarbon-containing feed with the catalyst composition of the first aspect in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute to obtain a first alkyl-demethylated effluent exiting the alkyl-demethylation zone.

In a third aspect, this disclosure provides process for making a catalyst composition for alkyl-demethylation of a C2+-hydrocarbyl-substituted aromatic hydrocarbon, the process comprising: (I) providing an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and mixtures and combinations of two or more thereof; (II) providing a source material of a first metal element M1; (III) dispersing the source material of the first metal element M1 on the oxide support material to obtain a catalyst composition precursor; (IV) calcining the catalyst composition precursor at a temperature in a range from 250 to 650° C. (preferably from 350 to 550° C., more preferably from 400 to 500° C.) to obtain a calcined catalyst precursor; and (V) contacting the calcined catalyst precursor with a reducing atmosphere under activating conditions to obtain the catalyst composition.

In a fourth aspect, this disclosure relates to the catalyst composition for alkyl-demethylation of a C2₊-hydrocarbyl-substituted aromatic hydrocarbon prepared by the process of the third aspect described summarily above and in detail below.

In a fifth aspect, this disclosure provides a process for converting a C2+-hydrocarbyl-substituted aromatic hydrocarbon, the process comprising: (1) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and (2) contacting the C6+ aromatic hydrocarbon-containing feed with the catalyst composition of D1 in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute, optionally to obtain an alkyl-demethylated effluent exiting the alkyl-demethylation zone.

In a sixth aspect, this disclosure relates to the catalyst composition precursor prepared in the process of the third aspect described summarily above and in detail below.

In a seventh aspect, this disclosure provides A process for converting a C2+-hydrocarbyl-substituted aromatic hydrocarbon, the process comprising: (i) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and (ii) contacting the C6+ aromatic hydrocarbon-containing feed with an alkyl-demethylation catalyst composition in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute, optionally to obtain a first alkyl-demethylated effluent exiting the alkyl-demethylation zone; wherein: the alkyl-demethylation catalyst composition comprises an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and combinations and mixtures of two or more thereof;

a first metal element M1 dispersed upon the oxide support material, wherein M1 is selected from Groups 7, 8, 9, and 10 elements, and combinations thereof; and molecular hydrogen is fed into the alkyl-demethylation zone at a molar ratio to the C6+ aromatic hydrocarbon-containing feed in a range from 1 to 8; preferably 2 to 8; more preferably 2 to 6; still more preferably 2 to 4; most preferably 3 to 4.

### DETAILED DESCRIPTION

This disclosure relates to conversion of aromatic hydrocarbons bearing a C2+-alkyl substitute and/or an aliphatic ring annelated to an aromatic ring into methyl-substituted aromatic hydrocarbons and, more specifically, catalytic demethylation from the C2+-alkyl substitute and/or the aliphatic ring of such aromatic hydrocarbons using catalyst compositions having low propensity to promote methyl removal from an aromatic ring and/or aromatic ring loss.

Various specific embodiments, versions and examples of this disclosure will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims. Section I: Definitions

In this disclosure, a process may be described as comprising at least one “step.” It should be understood that each step is an action or operation that may be carried out once or multiple times in the process, in a continuous or discontinuous fashion. Unless specified to the contrary or the context clearly indicates otherwise, multiple steps in a process may be conducted sequentially in the order as they are listed, with or without overlapping with one or more other step, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contain a certain level of error due to the limitation of the technique and equipment used for making the measurement.

As used herein, the indefinite articles “a” or “an” shall mean “at least one” unless specified to the contrary or the context clearly indicates otherwise. Thus, for example, embodiments using “a fractionation column” include embodiments where one, two or more fractionation columns are used, unless specified to the contrary or the context clearly indicates that only one fractionation column is used.

“Consisting essentially of,” as used herein, means a composition, feed, or effluent includes a given component or group of components at a concentration of at least 60 wt %, preferably at least 70 wt %, more preferably at least 80 wt %, more preferably at least 90 wt %, or still more preferably at least 95 wt %, based on the total weight of the composition, feed, or effluent.

“Hydrocarbon” means (i) any compound consisting of hydrogen and carbon atoms or (ii) any mixture of two or more such compounds in (i). The term “Cn hydrocarbon,” where n is a positive integer, means (i) any hydrocarbon compound comprising carbon atom(s) in its molecule at the total number of n, or (ii) any mixture of two or more such hydrocarbon compounds in (i). Thus, a C2 hydrocarbon can be ethane, ethylene, acetylene, or mixtures of at least two of them at any proportion. A “Cm to Cn hydrocarbon” or “Cm-Cn hydrocarbon,” where m and n are positive integers and m<n, means any of Cm, Cm+1, Cm+2, . . . , Cn−1, Cn hydrocarbons, or any mixtures of two or more thereof. Thus, a “C2 to C3 hydrocarbon” or “C2-C3 hydrocarbon” can be any of ethane, ethylene, acetylene, propane, propene, propyne, propadiene, cyclopropane, and any mixtures of two or more thereof at any proportion between and among the components. A “saturated C2-C3 hydrocarbon” can be ethane, propane, cyclopropane, or any mixture thereof of two or more thereof at any proportion. A “Cn+ hydrocarbon” means (i) any hydrocarbon compound comprising carbon atom(s) in its molecule at the total number of at least n, or (ii) any mixture of two or more such hydrocarbon compounds in (i). A “Cn-hydrocarbon” means (i) any hydrocarbon compound comprising carbon atoms in its molecule at the total number of at most n, or (ii) any mixture of two or more such hydrocarbon compounds in (i). A “Cm hydrocarbon stream” means a hydrocarbon stream consisting essentially of Cm hydrocarbon(s). A “Cm-Cn hydrocarbon stream” means a hydrocarbon stream consisting essentially of Cm-Cn hydrocarbon(s).

“Light hydrocarbon” means any C5-hydrocarbon.

As used herein, “wt %” means percentage by weight, “vol %” means percentage by volume, “mol %” means percentage by mole, “ppm” means parts per million, and “ppm wt” and “wppm” are used interchangeably to mean parts per million on a weight basis. All concentrations herein are expressed on the basis of the total amount of the composition in question. All ranges expressed herein should include both end points as two specific embodiments unless specified or indicated to the contrary.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6^{th} Edition, by F. Albert Cotton et al. (John Wiley & Sons, Inc., 1999).

“Liquid-phase” means reaction conditions in which aromatic hydrocarbons present in a reactor are substantially in liquid phase. “Substantially in liquid phase” means ≥90 wt %, preferably ≥95 wt %, preferably ≥99 wt %, and preferably the entirety of the aromatic hydrocarbons, is in liquid phase.

“Vapor-phase” means reaction conditions in which aromatic hydrocarbons present in a reactor are substantially in vapor phase. “Substantially in vapor phase” means ≥90 wt %, preferably ≥95 wt %, preferably ≥99 wt %, and preferably the entirety of the aromatic hydrocarbons, is in vapor phase.

“Methylated aromatic hydrocarbon” means an aromatic hydrocarbon comprising at least one methyl group and only methyl group(s) attached to the aromatic ring(s) therein. Examples of methylated aromatic hydrocarbons include toluene, xylenes, trimethylbenzenes, tetramethylbenzenes, pentamethylbenzene, hexamethylbenzene, methylnaphthalenes, dimethylnaphthalenes, trimethylnaphthalenes, tetramethylnaphthalenes, and the like.

“C2+-hydrocarbyl-substituted aromatic hydrocarbon” means an aromatic hydrocarbon comprising a substituted aromatic ring bearing a hydrocarbyl group, other than a methylated aromatic hydrocarbon bearing only methyl groups. A C2+-hydrocarbyl-substituted aromatic hydrocarbon may comprise (i) a C2+-hydrocarbyl group (e.g., a C2+-alkyl group) attached to an aromatic ring therein and/or (ii) an aliphatic ring annelated to an aromatic ring therein. Examples of C2+-hydrocarbyl-substituted aromatic hydrocarbons in scenario (i) include, but are not limited to (carbon numbers in parentheses): ethylbenzene (C8); ethylmethylbenzenes (C9); n-propylbenzene (C9); cumene (C9); ethyldimethylbenzenes (C10); diethylbenzenes (C10); n-propylmethylbenzenes (C10); methylcumenes (i.e., isopropylmethylbenzenes, C10); n-butylbenzene (C10); sec-butylbenzene (C10); tert-butylbenzene (C10); and the like. Examples of C2+-hydrocarbyl-substituted aromatic hydrocarbons in scenario (ii) include, but are not limited to (carbon numbers in parentheses): indane (C9); indene (C9); methylindanes (C10); methylindenes (C10); tetralin (C10); methyltetralin (C11), dimethylindanes (C11); ethylindanes (C11); and the like. Benzene and naphthalene are neither methylated aromatic hydrocarbons nor C2+-hydrocarbyl-substituted aromatic hydrocarbons.

“Alkyl-demethylation” means, in the presence of a suitable catalyst and molecular hydrogen, (i) the removal of one or more carbon atoms from a Cm (m≥2) alkyl group attached to an aromatic ring to leave a Cm′ residual alkyl group attached to the aromatic ring, wherein 1≤m′≤m−1, preferably m′=1; or (ii) the removal of one or more carbon atoms from a Cn aliphatic ring annelated to an aromatic ring to leave one or more residual alkyl groups (preferably methyl) comprising n′ carbon atoms in total attached to an aromatic ring, wherein 1≤n′≤n−1. Reactions (i) and (ii) are collectively called “alkyl-demethylation reactions” in this disclosure. Thus, alkyl-demethylation of a C2+-hydrocarbyl-substituted aromatic hydrocarbon comprising a Cm (m >2) alkyl group attached to an aromatic ring therein can result in an aromatic hydrocarbon substituted by a Cm−1 alkyl group, or a Cm−2 alkyl group, . . . , or a methyl group, as an alkyl-demethylated hydrocarbon. Alkyl-demethylation of a C2+-hydrocarbyl-substituted aromatic hydrocarbon comprising an n-member (n >5) aliphatic ring annelated to an aromatic ring therein can result in aromatic hydrocarbons substituted by at least one substitute (preferably two methyls) taken together having n−2, n−3, n−4, . . . , or 1 carbon atom(s). The removed methyl group(s) form light hydrocarbon(s) (preferably methane) in the presence of molecular hydrogen. With respect to C2+-hydrocarbyl-substituted aromatic hydrocarbons, the catalyst is desirably selective toward alkyl-demethylation defined above over (i) the removal of the Cn (n≥2) group attached to an aromatic ring in its entirety leaving no residual substitute and (ii) the removal of a methyl group attached to an aromatic ring leaving no residual substitute. Thus, further alkyl-demethylation of the alkyl-demethylated hydrocarbon(s) which are also C2+-hydrocarbyl-substituted aromatic hydrocarbons can result in increased amount of methylated aromatic hydrocarbons (e.g., tetramethylbenzenes, trimethylbenzenes, xylenes, and toluene). Without intending to be bound by a particular theory, such methylated aromatic hydrocarbons can be produced from C2+-hydrocarbyl-substituted aromatic hydrocarbons with or without the formation of the alkyl-demethylated hydrocarbons as intermediate C2+-hydrocarbyl-substituted aromatic hydrocarbons. Desirably, treating an aromatic hydrocarbon feed mixture comprising C2+-hydrocarbyl-substituted aromatic hydrocarbons by alkyl-demethylation may produce an aromatic hydrocarbon product mixture having a higher methyl to aromatic ring molar ratio compared to the feed mixture. Examples of alkyl-demethylation reactions of C2+-hydrocarbyl-substituted aromatic hydrocarbons to produce alkyl-demethylated hydrocarbon(s) include, but are not limited to the following (products marked with an asterisk (*) can be formed through hydrogenolysis of an annelated aliphatic ring without loss of one or more carbon atoms; these products may undergo subsequent alkyl-demethylation according to the disclosure herein):

| C2+-hydrocarbyl-substituted | Alkyl-demethylated hydrocarbon |
|---|---|
| aromatic hydrocarbon | product(s) |
| Ethylbenzene | Toluene |
| n-Propylbenzene | Ethylbenzene; toluene |
| Cumene | Ethylbenzene; toluene |
| Ethylmethylbenzenes | Xylenes |
| Indane | Ethylmethylbenzenes(*); |
| | n-propylbenzene(*); cumene(*); |
| | ethylbenzene; xylenes; toluene |
| 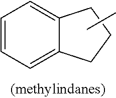 | Indane; propylmethylbenzenes(*); diethylbenzenes(*); ethylmethyl- benzenes; butylbenzenes(*); n- propylbenzene; cumene; ethyl- benzene; xylenes; toluene |
| 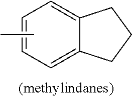 | Ethylmethylbenzenes; ethyldimethylbenzene(*); trimethylbenzenes; butylmethylbenezenes(*); propylmethylbenzenes(*); xylenes |
| 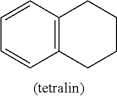 | Propylmethylbenzenes(*); diethylbenzene(*), butyl- benzenes(*); n-propylbenzene; cumene; ethylmethylbenzenes; xylenes; ethylbenzene; toluene |

“Dealkylation” of an alkyl group attached to an aromatic ring means the removal of the alkyl group in its entirety leaving no residual group attached to the aromatic ring. Thus, demethylation of the methyl group in toluene to form benzene, deethylation of the ethyl group in ethylbenzene to form benzene, deethylation of the ethyl group in ethylmethylbenzenes to form toluene, and the depropylation of the isopropyl group in cumene to form benzene are specific forms of dealkylation. Dealkylation of an alkylated aromatic hydrocarbon is typically effected in the presence of a catalyst selective for dealkylation over alkyl-demethylation, discussed above, in the presence of molecular hydrogen. The removed alkyl group in the dealkylation reaction forms light hydrocarbon(s) in the presence of molecular hydrogen.

An effluent or a feed is sometimes also called a stream in this disclosure. Where two or more streams are shown to form a joint stream and then supplied into a vessel, it should be interpreted to include alternatives where the streams are supplied separately to the vessel where appropriate. Likewise, where two or more streams are supplied separately to a vessel, it should be interpreted to include alternatives where the streams are combined before entering into the vessel as joint stream(s) where appropriate.

### Section II: The Alkyl-Demethylation Processes of This Disclosure

Alkyl-demethylation processes of this disclosure may occur in the presence of a suitable catalyst composition under a set of alkyl-demethylation conditions in an alkyl-demethylation zone of a reactor. On contacting a suitable catalyst composition, which may be formed from a precursor thereof, under the alkyl-demethylation conditions, a Cm+ (m≥2) alkyl group attached to an aromatic ring (e.g., a benzene ring, a naphthalene ring, and the like) loses one or more distal carbon atoms (i.e., a carbon atom from the alkyl group attached to the aromatic ring) to form preferably a methylated aromatic hydrocarbon with a methyl group attached to the aromatic ring. Preferably, the catalyst composition favors alkyl-demethylation of a Cm (m≥2) alkyl group attached to an aromatic ring over the demethylation of a methyl group attached to an aromatic ring under the alkyl-demethylation conditions. Thus, alkyl-demethylation of ethylbenzene (i.e., ethyl-demethylation) in the presence of a catalyst composition having suitable alkyl-demethylation specificity may result in the net production of toluene, with further demethylation to produce benzene being disfavored or occurring to a lesser extent. Alkyl-demethylation of ethylmethylbenzenes in the presence of a catalyst composition having suitable alkyl-demethylation specificity results in the net production of xylenes, with further demethylation to produce toluene and benzene being disfavored or occurring to a lesser extent. Similarly, alkyl-demethylation of C3-alkylbenzenes (i.e., benzene substituted by a single C3-alkyl group) in the presence of a suitable catalyst composition preferably produces toluene. Alkyl-demethylation of C3-alkylmethylbenzenes preferably results in the net production of xylenes. Thus, alkyl-demethylation processes may favor the production of methylated aromatic hydrocarbons (toluene, xylenes, trimethylbenzenes, and the like) over the production of benzene in the presence of a catalyst composition having suitable alkyl-demethylation specificity. Processes for converting aromatic hydrocarbons according to this disclosure can advantageously comprise one or more alkyl-demethylation process steps.

In the presence of a suitable catalyst composition under alkyl-demethylation conditions, aromatic hydrocarbons comprising an aliphatic ring annelated to an aromatic ring (e.g., indane, methylindanes, tetralin, methyltetralins, and the like) likewise may undergo scission of the aliphatic ring to form one or more linear or branched residual groups attached to the aromatic ring, with or without first losing a carbon atom from the aliphatic ring. Any C2+ linear or branched residual alkyl group formed via ring scission may subsequently undergo one or more steps of alkyl-demethylation reactions to be eventually converted into a methyl group attached to the aromatic ring, the further demethylation of which is disfavored in the presence of a catalyst composition having suitable specificity, as discussed herein. Thus, C2+-hydrocarbyl-substituted aromatic hydrocarbons such as indane, methylindanes, tetralin, and methyltetralins can be converted into methylated aromatic hydrocarbons in the alkyl-demethylation processes of this disclosure. In the processes of this disclosure including an alkyl-demethylation step occurring in an alkyl-demethylation zone, preferably the catalyst composition is capable of catalyzing the scission of aliphatic ring(s) annelated to an aromatic ring, with alkyl-demethylation taking place following aliphatic ring scission. In case the catalyst composition capable of promoting alkyl-demethylation is not sufficiently active for catalyzing scission of the aliphatic ring(s), an additional catalyst composition capable of promoting aliphatic ring scission, preferably in a selective manner, may be included in the alkyl-demethylation zone as well.

While alkyl-demethylation reactions as described above are favored in the alkyl-demethylation processes of this disclosure, it should be understood that certain side reactions other than the alkyl-demethylation reactions may occur to some degree in the presence of the catalyst composition under the alkyl-demethylation reaction conditions present in the alkyl-demethylation zone.

The hydrocarbon feed supplied to an alkyl-demethylation zone in the processes of this disclosure may comprise a C6+ aromatic hydrocarbon-containing stream comprising one or more C2+-hydrocarbyl-substituted aromatic hydrocarbons. The concentration of the C2+-hydrocarbyl-substituted aromatic hydrocarbons in the C6+ aromatic hydrocarbon-containing feed can range from c1 to c2 wt %, based on the total weight of the C6+ aromatic hydrocarbons in the feed within the zone, wherein c1 and c2 can be, independently, e.g., 2, 4, 5, 6, 8, 10, 15, 20, 25, 30, 35, 40, 45, 50, 55, 60, 65, 70, 75, 80, 85, 90, as long as c1 <c2. Thus, the feed subject to alkyl-demethylation according to the disclosure herein can comprise such C2+-hydrocarbyl-substituted aromatic hydrocarbons at relatively low to very high concentrations, depending on the source of the feed.

In certain embodiments, the C6+ aromatic hydrocarbon-containing feed supplied to the alkyl-demethylation zone can comprise C8 aromatics including ethylbenzene and xylenes at various concentrations, e.g., at 50 wt %, 60 wt %, 70 wt %, 80 wt %, 90 wt %, 95 wt % of total C8 aromatics, based on the total weight of the C6+ aromatic hydrocarbon-containing feed. In certain embodiments, the concentration of ethylbenzene in the feed supplied to the alkyl-demethylation zone can range from c(EB)1 to c(EB)2 wt %, based on the total weight of the C8 aromatic hydrocarbons contained in the feed, wherein c(EB)1 and c(EB)2 can be, independently, e.g., 2, 4, 5, 6, 8, 10, 15, 20, 25, 30, 35, 40, 45, or 50, as long as c(EB)1 <c(EB)2. The processes of this disclosure can be particularly advantageous when used to process such streams comprising high concentrations of ethylbenzene such as at ≥10 wt %, ≥20 wt %, or ≥30 wt %, based on the weight of all C8 aromatic hydrocarbons in the feed, to produce toluene. Advantageously, processing the ethylbenzene in this manner can minimize accumulation of the ethylbenzene in a xylenes loop. Through processes known to those having ordinary skill in the art, the toluene can subsequently be converted into additional quantities of xylenes, particularly p-xylene, via methylation with methanol and/or dimethyl ether, toluene disproportionation, and/or transalkylation with C9+ aromatic hydrocarbons, particularly methylated aromatic hydrocarbons such as trimethylbenzenes and tetramethylbenzenes.

In certain embodiments, the C6+ aromatic hydrocarbon-containing feed supplied to the alkyl-demethylation zone can comprise C9+ aromatic hydrocarbons including ethylmethylbenzenes, C3-alkyl substituted benzenes, indane, trimethylbenzenes, C4-alkyl substituted benzenes, methylindanes, tetramethylbenzenes, tetralin, methyltetralins, and the like, at various concentrations, e.g., at 50 wt %, 60 wt %, 70 wt %, 80 wt %, 90 wt %, 95 wt % of total C9+ aromatics, based on the total weight of the C6+ aromatic hydrocarbon-containing feed. In certain embodiments, the concentration of C9+ aromatic hydrocarbons bearing a C2+ hydrocarbyl substitute in the feed provided to the alkyl-demethylation zone can range from cx1 to cx2 wt %, based on the total weight of the C9+ aromatic hydrocarbons contained in the feed, wherein cx1 and cx2 can be, independently, e.g., 10, 15, 20, 25, 30, 35, 40, 45, 50, 55, 60, 65, 70, 75, 80, 85, or 90, as long as cx1 <cx2. The processes of this disclosure can be particularly advantageous when used to process such streams comprising high concentrations of C9+ aromatic hydrocarbons bearing a C2+ substitute such as at≥30 wt %, ≥40 wt %, ≥50 wt %, ≥60 wt %, ≥70 wt %, or≥80 wt %, based on the weight of all C9+ aromatic hydrocarbons in the feed. In this disclosure, C9+ aromatic hydrocarbons bearing a C2+ substitute can be conveniently converted into useful methylated aromatic hydrocarbons such as toluene, xylenes, and trimethylbenzenes. Through processes known to those having ordinary skill in the art, the toluene can be converted into additional quantities of xylenes, particularly p-xylene, via methylation with methanol and/or dimethyl ether, toluene disproportionation, and transalkylation with C9+ aromatic hydrocarbons, particularly methylated aromatic hydrocarbons such as trimethylbenzenes and tetramethylbenzenes. C9+ methylated aromatic hydrocarbons, including trimethylbenzenes, tetramethylbenzenes, and the like, can be converted into additional quantities of xylenes, particularly p-xylene, via transalkylation with benzene and/or toluene as well.

The alkyl-demethylation step is preferably carried out in the presence of molecular hydrogen co-fed into the alkyl-demethylation zone. The methyl group(s) removed in the alkyl-demthylation step in the alkyl-demethylation zone may be converted into light hydrocarbons such as methane in the presence of the molecular hydrogen. Hydrogen partial pressures in the alkyl-demethylation zone may range from p1 to p2 kilopascal, absolute, where p1 and p2 can be, independently, e.g., 50, 60, 70, 80, 90, 100, 200, 300, 400, 500, 600, 700, 800, 900, 1000, 1200, 1400, 1500, 1600, 1800, 2000, 2200, 2400, 2500, as long as p1 <p2.

The processes of this disclosure can include a reaction taking place in one or more alkyl-demethylation zones. An alkyl-demethylation zone can include a portion of a reactor, a full reactor, or multiple reactors, which may be in series or parallel. Where multiple alkyl-demethylation zones are present in the processes of this disclosure, the catalyst compositions and conditions for promoting alkyl-demethylation in them may be the same or different.

In various embodiments, the alkyl-demethylation conditions in the alkyl-demethylation zone can include a temperature in a range from t1 to t2° C., wherein t1 and t2 can be, independently, e.g., 180, 200, 220, 240, 250, 260, 280, 300, 320, 340, 350, 360, 380, 400, 420, 440, 450, 460, 480, or 500, as long as t1<t2. The alkyl-demethylation conditions in the alkyl-demethylation zone(s) can include an absolute pressure in a range from p1 to p2 kilopascal, wherein p1 and p2 can be, independently, e.g., 100, 150, 200, 250, 300, 350, 400, 450, 500, 550, 600, 650, 700, 750, 800, 850, 900, 950, 1000, 1200, 1400, 1500, 1600, 1800, 2000, 2200, 2400, 2500, 3000, 3500, 4000, 4500, or 5000, as long as p1 <p2. Partial pressure of hydrogen under the alkyl-demethylation conditions may range from h1 to h2 kilopascals, wherein h1 and h2 can be, independently, e.g., 50, 100, 150, 200, 250, 300, 350, 400, 450, 500, 600, 700, 800, 900, 1000, 1100, 1200, 1300, 1400, 1500, 1600, 1700, 1800, 1900, 2000, 2100, 2200, 2300, 2400, or 2500, as long as h1<h2. Thus, depending on temperature and pressure conditions, the alkyl-demethylation conditions in the alkyl-demethylation zone(s) can be such that the aromatic hydrocarbons in the alkyl-demethylation zone(s) are substantially in vapor phase, substantially in liquid phase, or a mixed phase comprising liquid phase and vapor phase at any ratio between the vapor phase and the liquid phase. The alkyl-demethylation conditions can include a molecular hydrogen to C6+ aromatic hydrocarbons molar ratio in a range from r1 to r2, where r1 and r2 can be, independently, e.g., 0.1, 0.2, 0.3, 0.4, 0.5, 1, 2, 3, 4, 5, 6, 7, 8, 9, 10, as long as r1<r2. The alkyl-demethylation conditions can further include a liquid weight hourly space velocity (“WHSV”) in a range from w1 to w2, where w1 and w2 can be, independently, e.g., 0.1, 0.2, 0.4, 0.5, 0.6, 0.8, 1, 2, 4, 5, 6, 8, 10, 12, 14, 15, 16, 18, or 20, as long as w1<w2.

Specifically, with respect to a C8 aromatic hydrocarbon stream comprising a majority by weight, or consisting essentially of, xylenes and ethylbenzene, preferably at least 5 wt % ethylbenzene based on a total weight of C6+ aromatic hydrocarbon-containing stream, such as a p-xylene depleted stream produced from a p-xylene separation process, the alkyl-demethylation conditions in the alkyl-demethylation zone(s) can include a temperature in a range from t3 to t4° C., wherein t3 and t4 can be, independently, e.g., 180, 200, 220, 240, 250, 260, 280, 300, 320, 340, 350, 360, 380, 400, 420, 440, 450, 460, 480, or 500, as long as t3 <t4. The alkyl-demethylation conditions in the alkyl-demethylation zone(s) can include an absolute pressure in a range from p3 to p4 kilopascal, wherein p3 and p4 can be, independently, e.g., 100, 150, 200, 250, 300 350, 400, 450, 500, 550, 600, 650, 700, 750, 800, 850, 900, 950, 1000, 1200, 1400, 1500, 1600, 1800, 2000, 2200, 2400, 2500, 3000, 3500, 4000, 4500, or 5000, as long as p3 <p4. Partial pressure of hydrogen under the alkyl-demethylation conditions may range from h1 to h2 kilopascals, wherein h1 and h2 can be, independently, e.g., 50, 100, 150, 200, 250, 300, 350, 400, 450, 500, 600, 700, 800, 900, 1000, 1100, 1200, 1300, 1400, 1500, 1600, 1700, 1800, 1900, 2000, 2100, 2200, 2300, 2400, or 250, as long as h1<h2. Thus, depending on temperature and pressure conditions, the alkyl-demethylation conditions in the alkyl-demethylation zone(s) can be such that the C8 aromatic hydrocarbons are substantially in vapor phase, substantially in liquid phase, or a mixed phase comprising liquid phase and vapor phase in any ratio. The alkyl-demethylation conditions can include a molecular hydrogen to C6+ aromatic hydrocarbons molar ratio in the alkyl-demethylation zone(s) in a range from r1 to r2, where r1 and r2 can be, independently, e.g., 0.1, 0.2, 0.3, 0.4, 0.5, 1, 2, 3, 4, 5, 6, 7, 8, 9, 10, 12, 14, 15, 16, 18, or 20, as long as r1 <r2. The alkyl-demethylation conditions in the alkyl-demethylation zone(s) can further include a weight hourly space velocity (“WHSV”) in a range from w1 to w2, where w1 and w2 can be, independently, e.g., 0.1, 0.2, 0.4, 0.5, 0.6, 0.8, 1, 2, 4, 5, 6, 8, 10, 12, 14, 15, 16, 18, or 20, as long as w1 <w2.

Specifically, with respect to a C9+ aromatic hydrocarbons stream comprising a majority by weight, or consisting essentially of, C9+ aromatic hydrocarbons, such as a C9+ aromatic hydrocarbons stream produced from p-xylene separation process or from another aromatic hydrocarbon source, preferably comprising at least 80 wt % C9+ aromatic hydrocarbons and at least 20 wt % C2+-hydrocarbyl-substituted C9+ aromatic hydrocarbons based on a total weight of C6+ aromatic hydrocarbon-containing stream, the alkyl-demethylation conditions in the alkyl-demethylation zone(s) can include a temperature in a range from t3 to t4° C., wherein t3 and t4 can be, independently, e.g., 180, 200, 220, 240, 250, 260, 280, 300, 320, 340, 350, 360, 380, 400, 420, 440, 450, 460, 480, or 500, as long as t3 <t4. The alkyl-demethylation conditions in the alkyl-demethylation zone(s) can include an absolute pressure in a range from p3 to p4 kilopascal, wherein p3 and p4 can be, independently, e.g., 100, 150, 200, 250, 300 350, 400, 450, 500, 550, 600, 650, 700, 750, 800, 850, 900, 950, 1000, 1200, 1400, 1500, 1600, 1800, 2000, 2200, 2400, 2500, 3000, 3500, 4000, 4500, or 5000, as long as p3 <p4. Partial pressure of hydrogen under the alkyl-demethylation conditions may range from h1 to h2 kilopascals, wherein h1 and h2 can be, independently, e.g., 50, 100, 150, 200, 250, 300, 350, 400, 450, 500, 600, 700, 800, 900, 1000, 1100, 1200, 1300, 1400, 1500, 1600, 1700, 1800, 1900, 2000, 2100, 2200, 2300, 2400, or 250, as long as h1 <h2. Thus, depending on temperature and pressure conditions, the alkyl-demethylation conditions in the alkyl-demethylation zone(s) can be such that the C9+ aromatic hydrocarbons are substantially in vapor phase, substantially in liquid phase, or a mixed phase comprising liquid phase and vapor phase in any ratio. The alkyl-demethylation conditions can include a molecular hydrogen to C6+ aromatic hydrocarbons molar ratio in the alkyl-demethylation zone(s) in a range from r1 to r2, where r1 and r2 can be, independently, e.g., 0.1, 0.2, 0.3, 0.4, 0.5, 1, 2, 3, 4, 5, 6, 7, 8, 9, 10, 12, 14, 15, 16, 18, or 20, as long as r1 <r2. The alkyl-demethylation conditions in the alkyl-demethylation zone(s) can further include a weight hourly space velocity (“WHSV”) in a range from w1 to w2, where w1 and w2 can be, independently, e.g., 0.1, 0.2, 0.4, 0.5, 0.6, 0.8, 1, 2, 4, 5, 6, 8, 10, 12, 14, 15, 16, 18, or 20, as long as w1 <w2.

Accordingly, processes for converting C2+-hydrocarbyl-substituted aromatic hydrocarbons via alkyl-demethylation according to this disclosure may comprise: providing a C6+ aromatic hydrocarbon-containing stream comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and contacting the C6+ aromatic hydrocarbon-containing stream comprising the C2+-hydrocarbyl-substituted aromatic hydrocarbon with a catalyst composition of this disclosure in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute to obtain a first alkyl-demethylated effluent exiting the alkyl-demethylation zone. As discussed further hereinbelow, the catalyst composition may preferably comprise an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and combinations and mixtures of two or more thereof; a first metal element M1 dispersed upon the oxide support material, wherein M1 is selected from Groups 7, 8, 9, and 10 elements, and combinations thereof; and an optional second metal element M2 dispersed upon the oxide support material, wherein M2 is selected from groups 11, 12, 13, and 14 elements excluding A1, and combinations thereof, wherein M2 is present at least where M1 is a single metal element.

At least a portion of M1 may be in elemental form when disposed upon the support material and the hydrogen chemisorption is measured. M1 may be substantially in elemental form, or a mixture of element form and a non-elemental form (e.g., an oxide or a metal salt) may be present upon the support material.

When measuring hydrogen chemisorption, the following procedure may be used: Roughly 250 mg of a catalyst composition precursor may be loaded into an Autochem 2920 instrument, which may then be ramped to 250° C. at 10° C./min under Ar flow, followed by a 30 minute hold at this temperature to drive off any moisture and other volatile species. After this drying step, 10% H₂ may be introduced to the system, and the catalyst composition precursor is heated to 450° C. at 10° C./min, followed by a 60 minute hold to reduce the transition metal and form an active catalyst composition. The catalyst composition is then cooled to 40° C. and 0.5 mL of H₂ is pulsed over the catalyst to allow H₂ to absorb onto the surface of the transition metal. The pulses are repeated until no further H₂ adsorption is detected via TCD. The dispersion is then calculated using the amount of H₂ adsorbed on the metal and the loading of metal in the catalyst composition.

Suitable oxide support materials for forming the catalyst compositions of This disclosure include alkaline earth metal oxides, silica, a composite of an alkaline earth metal oxide and Al₂O₃, a composite of ZnO and Al₂O₃, a lanthanide oxide, a composite of a lanthanide oxide and Al₂O₃, and combinations or mixtures of two or more thereof. More specific examples of suitable oxide support materials may include, for example, CaO, MgO, SrO, silica (preferably precipitated silica), a composite of MgO and Al₂O₃, such as a spinel formed from calcined hydrotalcite, and combinations and mixtures of two or more thereof. Suitable oxide support materials may further or alternately exhibit an alpha value of no greater than 2.5, preferably no greater than 2.0, and even more preferably no greater than 1.5. Measurement of the alpha value was performed based upon the conversion of n-hexane into lighter hydrocarbons. A reactor was loaded with about 1 cc of catalyst, and n-hexane was sparged into a stream of helium passed through the reactor at elevated temperature (1000° F.). An in-line GC was used to analyze the reactor effluent to determine the amount of hexane converted to products. The conversion of n-hexane by the catalyst relative to that produced by alumina under similar conditions provides the alpha value.

Contacting to obtain an alkyl-demethylated aromatic hydrocarbon according to this disclosure may exhibit at least one of the following: a positive methyl gain, a C2+-alkyl group conversion in a range from 30% to 100%, and an aromatic ring loss of no greater than 3%. More specific examples of the contacting steps may include those which exhibit at least one of the following: a xylene loss in a range from 0% to 15%, an ethylbenzene conversion in a range from 30% to 100%, a positive methyl gain, and an aromatic ring loss no greater than 3%. Other more specific examples of the contacting steps may include those that exhibit at least one of the following: a trimethylbenzenes loss in a range from 0% to 20%, a C2+-alkyl-substituted C9+ aromatic hydrocarbons conversion in a range from 30% to 100%, a positive methyl gain, and an aromatic ring loss no greater than 3%, more particularly instances in which contacting further exhibits at least one of the following: an ethyl group conversion from 30% to 100%, and a C3-alkyl group conversion from 30% to 100%.

Methyl gain may be determined by subtracting the amount of methyl groups in the product from the amount of methyl groups in the C6+-aromatic hydrocarbon-containing stream divided by the amount of methyl groups in the C6+-aromatic hydrocarbon-containing stream. A positive value represents a gain in methyl groups during alkyl-demethylation, and a negative value is reflective of a loss of methyl groups during alkyl-demethylation. Ring loss may be determined by subtracting the amount of aromatic rings in the product from the amount of aromatic rings in the C6+-aromatic hydrocarbon-containing stream and dividing the difference by the amount of aromatic rings in the C6+-aromatic hydrocarbon-containing stream. Xylene loss, ethylbenzene conversion, trimethylbenzenes conversion, and C2+-alkyl-substituted C9+ aromatic hydrocarbon conversion are determined similarly by dividing the difference in value for product and stream by the value in the C6+-aromatic hydrocarbon-containing stream.

Suitable alkyl-demethylation conditions may comprise at least one of the following: a presence of molecular hydrogen in the alkyl-demethylation zone at a partial pressure of hydrogen in a range from 50 to 2,500 kilopascal absolute, a temperature in a range from 180 to 500° C., an absolute total pressure in a range from 100 to 5,000 kilopascal, a WHSV in a range from 0.1 to 20 hour⁻¹, and a molar ratio of molecular hydrogen to the C6+ aromatic hydrocarbon-containing stream in a range from 0.1 to 10.

In any embodiment, the C6+ aromatic hydrocarbon-containing stream may comprise at least 80 wt % C8 aromatic hydrocarbons, and at least 5 wt % ethylbenzene based on a total weight of the C6+ aromatic hydrocarbon-containing stream. In any embodiment, the C6+ aromatic hydrocarbon-containing stream may comprise at least 80 wt % C9+ aromatic hydrocarbons, and at least 20 wt % C2+-hydrocarbyl-substituted C9+ aromatic hydrocarbons, based on a total weight of the C6+ aromatic hydrocarbon-containing stream. The C2+-hydrocarbyl-substituted aromatic hydrocarbons in either of these C6+ aromatic hydrocarbon-containing streams may be present substantially in vapor phase in the alkyl-demethylation zone, as defined herein.

### Section III: Catalyst Compositions for Performing Alkyl-Demethylation

The catalyst composition may comprise an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and combinations and mixtures of two or more thereof; a first metal element M1 dispersed upon the oxide support material, wherein M1 is selected from Groups 7, 8, 9, and 10 elements, and combinations thereof; and an optional second metal element M2 dispersed upon the oxide support material, wherein M2 is selected from groups 11, 12, 13, and 14 elements excluding A1, and combinations thereof, wherein M2 is present at least where M1 is a single metal element.

Without being bound by any theory or mechanism, the catalyst compositions of the present disclosure may feature M1 and/or M2 well dispersed upon the oxide support material, wherein the extent of metal dispersion may be correlated through the hydrogen chemisorption value. Higher hydrogen chemisorption values are believed to be reflective of increased metal dispersion. Preferably, the oxide support material used in the catalyst compositions of the present disclosure are substantially free of zeolites and alumina, since these materials have high surface acidity values. Oxide composites in which Al₂O₃ is not present as a discrete phase, such as a spinel formed from calcined hydrotalcite and similar oxide composites, may be suitable for use in the catalyst compositions of the present disclosure. More particular examples of oxide support materials suitable for use in the disclosure herein include those comprising a member selected from the group consisting of CaO, MgO, SrO, silica (preferably precipitated silica), a composite of MgO and Al₂O₃, and mixtures and combinations of two or more thereof.

The amount of the oxide support materials in the catalyst compositions disclosed herein can range from c(s)1 to c(s)2 wt %, where c(s)1 and c(s2)2 can be, independently, e.g., 2, 4, 5, 6, 8, 10, 15, 20, 25, 30, 35, 40, 45, 50, 55, 60, 65, 70, 75, 80, 85, 90, 95, 96, 97, 98, or 99, as long as c(s)1<c(s)2.

Preferably, the oxide support material in the catalyst compositions disclosed herein may exhibit a BET surface area of at least 25 m²/g, including 25 m²/g to 500 m²/g, or 25 m²/g to 200 m²/g, or 25 m²/g to 100 m²/g, or 50 m²/g to 300 m²/g, or 100 m²/g to 400 m²/g. To perform the BT surface area measurements, a Micrometrics TriStar 3000 instrument may be used. The sample may be heated at 350° C. and degassed using a vacuum pump, and then placed in He flow for several hours. The sample is then cooled to liquid nitrogen temperature, and nitrogen is physically adsorbed onto the sample. Desorption of the nitrogen may afford a Langmuir curve, from which the surface area can be derived.

Preferably, the catalyst composition may exhibit a hydrogen chemisorption value of 15%, 20%, 30%, 40%, 50%, 60%, 70%, 80%, 90%, based on a theoretic limit.

Catalyst compositions of the present disclosure may feature at least a portion of M1 and/or M2 in an elemental state, which may be mixed with a non-elemental state (e.g., an oxide or salt) or M1 and/or M2 may be present in a substantially elemental state. The substantially elemental state may be produced in situ under alkyl-demethylation conditions, as specified herein. Additionally or alternately, the elemental state may be produced upon exposing M1 and/or M2 at non-elemental state to a reducing atmosphere, e.g., a H₂-containing atmosphere, at a suitable temperature, either in a separate, ex-situ catalyst activation step and/or an in-situ catalyst activation step taking place in an alkyl-demethylation zone. Thus, for example, Rh, Re, Ru, Cu, Ag, Au, Ga, Sn, and the like, in non-elemental state may be converted into partly, substantially, or completely, elemental state, upon contacting with a H₂-containing atmosphere under activation conditions.

M1 can be any Group 7, 8, 9, and 10 elements, or mixtures and combinations of two or more thereof. Preferably, M1 is selected from Ni, Re, Ru, Rh, Ir, and combinations thereof; preferably M1 is selected from Ru, Rh, Ir, and combinations thereof; more preferably M1 is selected from Ru, Rh, and combinations thereof; most preferably M1 is Rh.

In various embodiments, the concentration of M1, based on the total weight of the catalyst composition, can range from c(m1)1 to c(m1)2 wt %, where c(m1)1 and c(m1)2 can be, independently, e.g., 0.01, 0.02, 0.04, 0.05, 0.06, 0.08, 0.1, 0.2, 0.4, 0.5, 0.6, 0.8, 1, 2, 4, 5, 6, 8, 10, as long as c(m1)1 <c(m1)2. Particular examples may include those in which the catalyst composition comprises 0.1 to 5 wt % of M1, preferably Rh, expressed as a weight percentage of M1 in an elemental state relative to a total weight of the catalyst composition. More specific examples of the catalyst compositions may include those in which the catalyst composition comprises 0.1 to 2 wt % or M1, preferably Rh, expressed as a weight percentage of the transition metal element in an elemental state relative to a total weight of the catalyst composition.

M2 may be present or absent where M1 is a combination of two or more elements as described above. In embodiments where M2 is absent, preferably M1 comprises a combination of Ru and Rh, or a combination or Ir and Rh.

Where M1 is a single metal element as described above, M2 is present.

Preferably M2 is selected from Cu, Ag, Au, Zn, Ga, In, Ge, Sn, and combinations thereof; preferably M2 is selected from Cu, Ag, Au, Ga, and combinations thereof; more preferably M2 is selected from Cu, Ag, Au, and combinations thereof; most preferably M2 is Ag.

In various embodiments, M2 can have a concentration from 0.01 to 5 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M2 on the basis of the total weight of the catalyst composition.

Preferably, where both M1 and M2 are present, the catalyst composition exhibits a molar ratio of M1 to M2 in a range from r1 to r2, where r1 and r2 can be, independently, e.g., 0.1, 0.2, 0.3, 0.4, 0.5, 0.6, 0.7, 0.8, 0.9, 1, 2, 3, 4, 5, 6, 7, 8, 9, and 10.

Preferred combinations of M1/M2 include: Rh/Ag; Rh/Cu; Rh/Au. A most preferred M1/M2 combination is Rh/Ag.

### Section IV: Processes for Making the Catalyst Compositions and Catalyst Composition Precursors

One aspect of this disclosure relates to processes for making a catalyst composition for alkyl-demethylation of a C2+-hydrocarbyl-substituted hydrocarbon, such as a catalyst composition disclosed above. The process can comprise one or more of (I) providing an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and mixtures and combinations of two or more thereof; (II) providing a source material of a first metal element M1; (III) dispersing the source material of the first metal element M1 on the oxide support material to obtain a catalyst composition precursor; (IV) calcining the catalyst composition precursor at a temperature in a range from 250 to 650° C. (preferably from 350 to 550° C., more preferably from 400 to 500° C.) to obtain a calcined catalyst precursor; and (V) contacting the calcined catalyst precursor with a reducing atmosphere under activating conditions to obtain the catalyst composition.

It has been found that by calcining the catalyst composition precursor at a relatively high temperature, a catalyst composition with exceptionally high alkyl-demethylation performance may be obtained. Thus, the calcination temperature in step (IV) can range from T1 to T2° C., where T1 and T2 can be, independently, e.g., 250, 260, 280, 300, 320, 340, 350, 360, 380, 400, 420, 440, 450, 460, 480, 500, 520, 540, 550, 560, 580, 600, 620, 640, 650, as long as T1<T2. Preferably T1=350 and T2=600. Preferably T1=350 and T2=550. Preferably T1=400 and T2=500. Without intending to be bound by a particular theory, it is believed that calcining at a relatively high temperature can result in a better dispersion of the metal element(s) on the surface of the oxide support material. At higher than 650° C., the metal elements may sinter, resulting in poorer dispersion.

In a particularly desirable embodiment, the oxide support material is substantially free of a zeolite and discrete alumina. In another embodiment, the oxide support can comprise, consist essentially of, or consist of silica.

In one preferred embodiment, the source material of the first metal element M1 comprises a salt of the first metal element M1. M1 can be a metal or combinations/mixtures of metal elements for M1 in other aspects of this disclosure as described above and below.

In certain embodiments, step (III) of dispersing the source material of the metal element M1 comprises: (Ma) forming a first dispersion comprising the source material of the first metal element M1 and a first liquid dispersant; (Mb) contacting the oxide support material with the first dispersion of the source material of the first metal element M1 to obtain a mixture of the oxide support material and the source material; and (Inc) optionally drying the mixture of the oxide support material and the source material to form a dried mixture of the oxide support material and the source material.

In certain embodiments, wherein the process further comprises, before step (IV), a step (Ha) below: (IIa) providing a source material of a second metal element M2 differing from the first metal element M1, where M2 is selected from Groups 11, 12, 13, 14, and 15 excluding A1, and combinations thereof; and step (III) comprises: (Ind) forming a second dispersion comprising the source material of the second metal element M2 and a second liquid dispersant; (IIIe) contacting the oxide support material with the second dispersion of the source material of the second t metal element M2 to obtain a mixture of the oxide support material and the source material of the second metal element M2; and the catalyst composition precursor comprises both the first metal element M1 and the second metal element M2. In certain specific embodiments, the first liquid dispersant and the second liquid dispersant comprise the same material, and the first dispersion and the second dispersion are the same dispersion comprising both the source material of the first metal element M1 and the source material of the second metal M2.

In a preferred embodiment, the first liquid dispersant and/or the second liquid dispersant can comprise, consistent essentially of, or consist of water. The first dispersion and/or the second dispersion can be a solution, a colloidal mixture, or a suspension dispersion.

In certain embodiments, the first dispersion and/or the second dispersion further comprises a linking agent comprising at least two functional groups capable of promoting (i) linkage between the source material of the first metal element M1 and the oxide support material and/or (ii) linkage between the source material of the first metal element M2 and the oxide support material. In certain specific embodiments, the linking agent comprises an amino alcohol, an amino acid, a glycol, or a mixture or combination of two or more thereof.

In step (V), the reducing atmosphere can preferably comprise molecular hydrogen, with or without an inert gas such as N2, He, Ne, Ar, Kr, and the like. In certain embodiments, after step (V) contacting the calcined catalyst precursor with a reducing atmosphere under activating conditions, the metal oxide support material exhibits an alpha value of no greater than 2.5, preferably no greater than 2.0, more preferably no greater than 1.5.

Upon completion of activation in step (V), the first metal element M1 is preferably present substantially in an elemental state.

The first metal element M1 may be selected from the group consisting of Groups 7, 8, 9 and 10 elements; preferably M1 is selected from Ni, Re, Ru, Rh, Ir, and combinations thereof; preferably M1 is selected from Ru, Rh, Ir, and combinations thereof; more preferably M1 is selected from Ru, Rh, and combinations thereof; most preferably M1 is Rh.

Preferably the catalyst composition upon completion of step (V) comprises M1 at a concentration from 0.01 to 10 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M1 on the basis of the total weight of the catalyst composition.

Preferably the second metal element M2 is selected from Cu, Ag, Au, Zn, Ga, In, Ge, Sn, and combinations thereof; preferably M2 is selected from Cu, Ag, Au, Ga, and combinations thereof; more preferably M2 is selected from Cu, Ag, Au, and combinations thereof; most preferably M2 is Ag.

Preferably the catalyst composition upon completion of step (V) comprises M2 at a concentration from 0.01 to 5 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M2 on the basis of the total weight of the catalyst composition.

Preferably after contacting the calcined catalyst precursor with the reducing atmosphere under activating conditions in step (V), the catalyst composition exhibits a hydrogen chemisorption value of at least 15%, preferably at least 50%.

Preferably, the activating conditions in step (V) can comprise at least one of the following: a temperature in a range from 200 to 600° C. (preferably from 300 to 550° C.; preferably from 400 to 500° C.); a hydrogen partial pressure in a range from 5 to 1000 (preferably 50 to 800, preferably 100 to 700, preferably 200 to 600, preferably 300 to 500) kilopascal absolute; and a total pressure in a range from 100 to 1,000 (preferably 50 to 800, preferably 100 to 700, preferably 200 to 600, preferably 300 to 500) kilopascal absolute.

Yet another aspect of this disclosure relates to the catalyst composition for alkyl-demethylation of a C2+-hydrocarbyl-substituted aromatic hydrocarbon prepared by a process as described above. Another aspect of this disclosure relates to process for converting a C2+-hydrocarbyl-substituted aromatic hydrocarbon, the process comprising:(1) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and (2) contacting the C6+ aromatic hydrocarbon-containing feed with the catalyst composition of for alkyl-demethylation of a C2+-hydrocarbyl-substituted aromatic hydrocarbon prepared by a process as described above in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute, optionally to obtain an alkyl-demethylated effluent exiting the alkyl-demethylation zone.

Yet another aspect of this disclosure relates to the calcined catalyst precursor for alkyl-demethylation of a C2+-hydrocarbyl-substituted aromatic hydrocarbon prepared by a process as described above.

Yet another aspect of this disclosure relates to the catalyst composition precursor prepared by a process as described above.

Yet another aspect of this disclosure relates to the catalyst composition precursor for alkyl-demethylation of a C2+-hydrocarbyl-substituted aromatic hydrocarbon prepared by a process as described above.

Section V: Alkyl-Demethylation Processes at a High H₂/HC molar ratio

Another aspect of this disclosure relates to a process for converting a C2+-hydrocarbyl-substituted aromatic hydrocarbon, the process comprising: (i) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and (ii) contacting the C6+ aromatic hydrocarbon-containing feed with an alkyl-demethylation catalyst composition in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute, optionally to obtain a first alkyl-demethylated effluent exiting the alkyl-demethylation zone; wherein: the alkyl-demethylation catalyst composition comprises an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and combinations and mixtures of two or more thereof; a first metal element M1 dispersed upon the oxide support material, wherein M1 is selected from Groups 7, 8, 9, and 10 elements, and combinations thereof; and molecular hydrogen is fed into the alkyl-demethylation zone at a molar ratio to the C6+ aromatic hydrocarbon-containing feed in a range from 1 to 8; preferably 2 to 8; more preferably 2 to 6; still more preferably 2 to 4; most preferably 3 to 4. A H₂/HC molar ratio≥8 can lead to undesirable ring loss and hydrogenation of the aromatic rings.

It has been found that a relatively high molar ratio of molecular hydrogen to hydrocarbons (“H₂/HC molar ratio”) can result in particularly desirable results, including but not limited to at least one of the following: a high methyl gain, a low ring loss, and a high C2+-hydrocarbyl conversion.

This disclosure is further illustrated by the following non-limiting Examples.

### Section VI: EXAMPLES

### Part A: Fabrication of Calcined Catalyst Precursors

### Example A1 (Comparative)

### Fabrication of 1 wt % Rh on Calcined Hydrotalcite MG-30

Rh (1 wt %) was deposited on calcined hydrotalcite (calcined MG30, available from Sasol) extrudates by an incipient wetness method. Calcination of the hydrotalcite prior to Rh deposition resulted in formation of a spinel. The spinel formed following calcination of MG30 hydrotalcite (41.46% Al, 13.0% Mg, balance oxygen) had a BET surface area of 196 m²/g, a 0.45 cm³/g pore volume, and a pore size centered at 66 A. As an example preparation, 1% Rh was loaded as follows: 2.007 g of rhodium nitrate water solution containing 10.066 wt % Rh was diluted with distilled water. The total volume of the rhodium nitrate solution after dilution was 8.55 ml, a volume which represented 95% of the solution absorption capacity of 20 g of a MG30 calcined hydrotalcite extrudate. After Rh impregnation by incipient wetting, the sample was dried in air at 250° F. (120° C.) for 16 hours, and then further calcined in air at 572° F. (300° C.) for 1 hr. The furnace was ramped at rate of about 5° F./minute (about 2.8° C./minute). During calcination, the air flow was adjusted to 5 volumes per catalyst volume per minute. Calcined catalyst precursors having Rh loadings of 0.06, 0.13, 0.25, 0.50, 0.75, and 1.25 wt % were prepared in a similar manner

### Example A2 (Comparative)

### Fabrication of Rh on Calcined Hydrotalcite MG-70

Calcined catalyst precursor samples were also made from a spinel formed through calcination of MG70 hydrotalcite (available from Sasol, 21.97% Al, 30.53% Mg, balance oxygen). The spinel formed through calcination of MG70 hydrotalcite had a BET surface area of 197 m²/g, a 0.30 cm³/g pore volume, and a pore size centered at 56 A. In general, this oxide support afforded similar catalytic performance to that provided by the spinel formed through calcination of MG30 hydrotalcite (data not shown below).

### Example A3 (Inventive)

### Fabrication of 1 wt % Rh and 0.5 wt % Ag on Calcined Hydrotalcite MG-30

The sample of 1 wt % Rh/0.5 wt % Ag/hydrotalcite-MG30 was prepared by co-impregnation of Rh and Ag nitrate water solutions of a calcined MG-30 extrudate. As an example of sample preparation, 0.1598 g silver nitrate was added into 2.0776 g of rhodium nitrate water solution with a concentration of 9.771 wt % Rh. The Rh-Ag solution were diluted with distilled water. The total solution volume of Rh-Ag solution adjusted with distilled water was 8.55 ml, which was 95% of the solution absorption capacity of 20 g of calcined MG30 extrudate. After impregnation, the Rh-Ag containing sample was dried in air at 250° F. (120° C.) for 16 hours and calcined in air at 572° F. (300° C.) for 1 hour. The furnace was ramped at a rate of 5° F./min. During calcination, air flow was adjusted at 5 volumes per catalyst volume per minute.

### Example A4 (Inventive)

### Fabrication of 1 wt % Rh and 0.25 wt % Cu Calcined Hydrotalcite MG-30

In a manner similar to Example A3, a calcined catalyst precursor comprising 1 wt % Rh, 0.25% Cu, and calcined MG30 was made, where cupric nitrate trihydrate was used as Cu source.

### Example A5 (Inventive)

### Fabrication of 1 wt % Rh and 0.3 wt % Sn on Calcined Hydrotalcite MG-30

In a manner similar to Example A3, a calcined catalyst precursor comprising 1 wt % Rh, 0.3 wt % Sn, and calcined MG30 was made, where tin chloride dihydrate (SnCl₂.2H₂O) was used as Sn source.

### Example A6 (Inventive)

### Fabrication of 1 wt % Rh and 0.5 wt % Au on Calcined Hydrotalcite MG-30

In a manner similar to Example A3, a calcined catalyst precursor comprising 1 wt % Rh, 0.5 wt % Au, and calcined MG30 was made, where gold chloride trihydrate used as Au source.

### Example A7 (Inventive)

### Fabrication of 1 wt % Rh and 0.5 wt % Ga on Calcined Hydrotalcite MG-30

In a manner similar to Example A3, a calcined catalyst precursor comprising 1 wt % Rh, 0.5 wt % Ga, and calcined MG30 was made, where gallium nitrate (Ga(NO₃)₃) was used as Ga source.

### Example A8 (Inventive)

### Fabrication of 0.75 wt % Rh and 0.25 wt % Ir on Calcined Hydrotalcite MG-30

In a manner similar to Example A3, a calcined catalyst precursor comprising 0.75 wt % Rh, 0.25% Ir, and calcined MG30 was made, where iridium chloride hydrate was used as Ir source.

### Example A9 (Inventive)

### Fabrication of 1 wt % Rh and 0.25 wt % Ru on Calcined Hydrotalcite MG-30

In a manner similar to Example A3, a calcined catalyst precursor comprising 0.75 wt % Rh, 0.25 wt % Ru, and calcined MG30 was made, where ruthenium nitrosyl nitrate solution was used as Ru source.

### Example A10 (Inventive)

### Fabrication of 1 wt % Rh and 0.25 wt % Ag on Calcined Hydrotalcite MG-30

In a manner similar to Example A3, a calcined catalyst precursor comprising 1 wt % Rh, 0.25 wt % Ag, and calcined MG30 was made.

### Example A11 (Inventive)

### Fabrication of 1 wt % Rh and 0.75 wt % Ag on Calcined Hydrotalcite MG-30

In a manner similar to Example A3, a calcined catalyst precursor comprising 1 wt % Rh, 0.75% Ag, and calcined MG30 was made.

### Example A12 (Comparative)

### Fabrication of 0.5 wt % Rh on Al₂O₃

In a manner similar to Example A3, a calcined catalyst precursor comprising 0.5 wt % Rh on a gamma-Al₂O₃ support was made.

Part B: Evaluation of Catalyst Compositions for Converting an Aromatic Feed by Alkyl-Demethylation

In the following examples in this Part B, alkyl-demethylation catalyst compositions were prepared from the calcined catalyst precursors in the examples in Part A, which were then evaluated for performance in alkyl-demethylation in contacting an aromatic hydrocarbon-containing feed (hereinafter “aromatic feed”). 0.5g of a calcined catalyst precursor fabricated in examples in Part A above, sized through a 20-40 mesh sieve, was diluted with silicon carbide to form a mixture. The mixture was packed in a packed bed reactor. The calcined catalyst precursor was reduced prior to introducing an aromatic feed thereto. Reduction was performed by flowing hydrogen gas over the calcined catalyst precursor for 3 hours at 450° C. to prepare the catalyst composition. Following reduction, the reactor was cooled to the specified run temperature and set to run pressure before introducing the aromatic feed and molecular hydrogen. The aromatic feed as tested comprised 53% trimethylbenzenes, 24% methylethylbenzenes, and 22% other C8+ alkylaromatics, and 1% other hydrocarbons, based on the total weight of the feed. Typical alkyl-demethylation conditions included a temperature of 320° C.-420° C., a pressure of 50 to 200 psig (345 to 1379 kilopascal gauge), a hydrogen to hydrocarbon molar ratio (“H₂/HC Ratio”) from 1 to 4, and a space velocity (“WHSV”) from 0.5-10 hour⁻¹. For avoidance of doubt, a “H₂/HC ratio of x” means x moles of H₂ per mole of hydrocarbons. In all Examples B1-B8 below, the alkyl-demethylation pressure was 100 psig (689 kilopascal gauge). The effluent exiting the packed reactor was analyzed for chemical composition using, inter alia, gas chromatography. Conversion of ethyl group (“Ethyl Conversion” or “Et Conv.”), conversion of propyl groups (“Propyl Conversion” or “Pr Conv.”), conversion of trimethylbenzenes (“TMB Conv.”), and loss of aromatic rings (“Ring Loss”) were calculated from the compositions of the effluent and the aromatic feed to evaluate the performances of the various alkyl-demethylation catalyst compositions after activation.

Methyl Gain (“Me Gain”) is one parameter that was used to characterize the reaction products formed from the aromatic feeds after being catalytically processed. Methyl gain, which can be a positive or negative value, represents the increase or decrease in methyl group content of the reaction product in comparison to the feed. Methyl gain in this disclosure is calculated with the equation G(Me)=(n1−n2)/n2*100%, wherein G(Me) is Methyl Gain in the reaction, n1 is the number of moles of methyl group attached to an aromatic ring in the reaction product and n2 is the number of moles of methyl group attached to an aromatic ring in the feed provided to the alkyl-demethylation zone. A negative G(Me) indicates a net loss of aromatic ring, which is generally undesirable.

### Example B1 (Comparative)

### Evaluation of a Catalyst Composition Prepared from the Calcined Catalyst Precursor of Example A1

The calcined catalyst precursor of comparative example A1, comprising 1 wt % Rh on a calcined MG-30 support, was used in this example. The metal content in the catalyst composition, alky-demethylation conditions and catalyst performance data are included in TABLE I below. Testing was conducted under varying alkyl-demethylation conditions in Examples B 1-a, B 1-b, B 1-c, and B1-d, as shown in TABLE I.

### Example B2 (Inventive)

### Evaluation of a Catalyst Composition Prepared from the Calcined Catalyst Precursor of Example A10

The calcined catalyst precursor of example A10, comprising 1 wt % Rh and 0.25 wt % Ag on a calcined MG-30 support, was used in this example. The metal content in the catalyst composition, alky-demethylation conditions and catalyst performance data are included in TABLE I below. Testing was conducted under varying alkyl-demethylation conditions in Examples B2-a, and B2-b, as shown in TABLE I.

### Example B3 (Inventive)

### Evaluation of a Catalyst Composition Prepared from the Calcined Catalyst Precursor of Example A3

The calcined catalyst precursor of example A3, comprising 1 wt % Rh and 0.5 wt % Ag on a calcined MG-30 support, was used in this example. The metal content in the catalyst composition, alky-demethylation conditions and catalyst performance data are included in TABLE I below. Testing was conducted under varying alkyl-demethylation conditions in Examples B3-a, B3-b, B3-c, B3-d, B3-e, and B3-f, as shown in TABLE I. In all data tables in this disclosure, the concentrations of metal(s) are wt %, based on the total weight of the compositions in question.

### Example B4 (Inventive)

### Evaluation of a Catalyst Composition Prepared from the Calcined Catalyst Precursor of Example All

The calcined catalyst precursor of example All, comprising 1 wt % Rh and 0.75 wt % Ag on a calcined MG-30 support, was used in this example. The metal content in the catalyst composition, alky-demethylation conditions and catalyst performance data are included in TABLE I below. Testing was conducted under varying alkyl-demethylation conditions in Examples B4-a, and B4-b, as shown in TABLE I.

### Examples B5-B10 (Inventive)

### Evaluation of the Catalyst Compositions Prepared from the Calcined Catalyst Precursors of Examples A4, A5, A6, A7, A8, and A9, Respectively

The calcined catalyst precursors of Examples A4, A5, A6, A7, A8, and A9, respectively, were used in these examples. The metal contents in the catalyst compositions, alky-demethylation conditions and catalyst performance data are included in TABLE I below. It is believed that the negative Ring Loss values in the TABLEs in this disclosure are produced due to reasonable experimental errors. It is believed that they indicate a very low Ring Loss close to zero.

As can be seen from TABLE I, compared to the comparative catalyst composition used in Example B1 comprising only Rh at 1 wt %, the inventive bi-metallic catalyst composition used in Example B3, comprising 1 wt % Rh and 0.5 wt % of Ag, exhibited significantly higher Methyl Gain and significantly lower Ring Loss at comparably high Ethyl Conversion and Propyls Conversion. The comparative catalyst composition used in Example B1 actually resulted a net loss of methyl groups from the aromatic rings, as indicated by the —1.48% of Methyl Gain. In stark contrast, the inventive catalyst composition used in Example B3 demonstrated a 5.22% of Methyl Gain. In terms of Ring Loss, the comparative catalyst composition used in Example B1 is very high, at 2.43%, while the inventive catalyst composition used in Example B3 is extremely low, at only 0.15%. Moreover, the Rh/Ag-containing catalyst composition used in Example B3 demonstrated much lower TMB Conversion (7.20%) compared to the comparative catalyst composition used in Example B1 (18.84 wt %). The catalyst compositions used in Examples B7 and B8, comprising Rh/Ir combination and Rh/Ru combinations, also exhibited surprisingly high Methyl Gain and very low Ring Loss. Data in Examples B2, B3, and B4 in TABLE I indicate that the catalyst compositions comprising, in addition to Rh at 1 wt %, Ag at 0.25 wt %, 0.50 wt %, and 0.75 wt %, respectively, all performed very well in the tests. They all resulted in exceptionally high Methyl Gain, significantly lower Ring Loss, and significantly lower TMB Conversion compared to the catalyst composition used in Example B1 comprising only Rh at 1 wt %. Data in TABLE I show that the performance of the alkyl-demethylation catalysts can be fine-tuned by altering the reaction conditions such as temperature, WHSV, and H₂/HC ratio. Increasing temperature generally leads to increased ethyl and propyl conversion and decreased ring loss.

TABLE I

| | | | | | TMB | Et | Pr | Me | Ring |
|---|---|---|---|---|---|---|---|---|---|
| Ex. | | Temp | WHSV | H₂/HC | Conv. | Conv. | Conv. | Gain | Loss |
| No. | Metal(s) | (° C.) | (hr⁻¹) | Ratio | (%) | (%) | (%) | (%) | (%) |
| B1-a | 1% Rh | 360 | 4 | 3 | 16.69 | 64.46 | 51.83 | −1.87 | 3.42 |
| B1-b | | 360 | 6 | 3 | 10.37 | 49.87 | 36.49 | −0.51 | 2.48 |
| B1-c | | 370 | 6 | 3 | 16.01 | 65.57 | 53.14 | −0.78 | 2.15 |
| B1-d | | 375 | 6 | 3 | 18.84 | 73.79 | 67.02 | −1.48 | 2.43 |
| B2-a | 1% Rh; | 370 | 6 | 4 | 0.17 | 41.94 | 36.41 | 6.3 | −0.26 |
| B2-b | 0.25% Ag | 390 | 6 | 4 | 8.25 | 67.63 | 59.64 | 6.41 | −0.88 |
| B3-a | 1% Rh; | 360 | 4 | 3 | 1.87 | 44.15 | 33.24 | 3.78 | 0.95 |
| B3-b | 0.5% Ag | 360 | 6 | 3 | 0.22 | 32.23 | 26.95 | 3.18 | 0.55 |
| B3-c | | 370 | 6 | 3 | 1.59 | 44.30 | 31.95 | 4.07 | 0.11 |
| B3-d | | 370 | 6 | 4 | 0.65 | 36.67 | 31.98 | 5.15 | −0.37 |
| B3-e | | 390 | 6 | 3 | 7.20 | 72.11 | 66.60 | 5.22 | 0.15 |
| B3-f | | 390 | 6 | 4 | 5.60 | 61.06 | 53.48 | 6.60 | −0.82 |
| B4-a | 1% Rh; | 370 | 6 | 4 | −0.53 | 28.41 | 23.58 | 4.55 | −0.51 |
| B4-b | 0.75% Ag | 390 | 6 | 4 | 1.73 | 48.37 | 40.75 | 6.71 | −1.17 |
| B5 | 1% Rh; | 400 | 6 | 3 | 17.11 | 69.27 | 71.62 | −1.05 | 0.26 |
| | 0.25% Cu | | | | | | | | |
| B6 | 1% Rh; | 360 | 2.5 | 2 | 4.60 | 28.92 | 14.62 | −2.18 | 2.82 |
| | 0.3% Sn | | | | | | | | |
| B7 | 1% Rh; | 375 | 6 | 3 | 15.88 | 68.71 | 64.52 | 0.29 | 1.47 |
| | 0.5% Au | | | | | | | | |
| B8 | 1% Rh; | 370 | 5 | 2 | 9.50 | 43.95 | 31.82 | −0.70 | 1.83 |
| | 0.5% Ga | | | | | | | | |
| B9 | 0.75% Rh; | 390 | 6 | 3 | 17.59 | 76.71 | 75.43 | 1.33 | 0.23 |
| | 0.25% Ir | | | | | | | | |
| B10 | 0.75% Rh; | 390 | 6 | 3 | 16.56 | 78.85 | 78.02 | 1.09 | 0.49 |
| | 0.25% Ru | | | | | | | | |

Part C: Evaluation of Calcination Temperature on the Performance of Alkyl-demethylation Catalyst Compositions

In this Part C, a series of calcined catalyst precursors comprising 1 wt % Rh supported on a calcined MG-30 were fabricated using the identical process described in Example A1 above, except the calcination temperature of the dried mixture of MG-30 and Rh source material (i.e. the precursor catalyst composition) upon impregnation was varied. In Examples CA-1, CA-2, CA-3, CA-4, and CA-5, the calcination temperature used was 300° C., 350° C., 400° C., 450° C., and 500° C., respectively.

In Examples CB-1, CB-2, CB-3, CB-4, and CB-5, the calcined catalyst precursors of Examples CA-1, CA-2, CA-3, CA-4, and CA-5 above, respectively were reduced and evaluated for alkyl-demethylation performances in experiments similar to those described in Part B above, using the same aromatic feed. Data of the precursor catalyst composition calcination temperature (“Cal. Temp”), alkyl-demethylation conditions (Temperature (“Temp”), WHSV, and H₂/HC molar ratio), as well as catalyst performances in terms of TMB Conversion, Ethyl Conversion, Propyls Conversion, Methyl Gain, and Ring Loss are presented in TABLE II below.

TABLE II

| | | Alkyl-Demethylation | | | TMB | Et | Pr | Me | Ring |
|---|---|---|---|---|---|---|---|---|---|
| Ex. | Cal. Temp | Temp | WHSV | H₂/HC | Conv. | Conv. | Conv. | Gain | Loss |
| No. | (° C.) | (° C.) | (hr⁻¹) | Ratio | (%) | (%) | (%) | (%) | (%) |
| CB-1 | 300 | 370 | 6 | 4 | 15.08 | 68.07 | 58.38 | 0.44 | 1.99 |
| CB-2 | 350 | 380 | 6 | 4 | 11.08 | 59.44 | 52.78 | 3.6 | −0.25 |
| CB-3 | 400 | 380 | 6 | 4 | 18.53 | 78.5 | 72 | 1.26 | 1.23 |
| CB-4 | 450 | 380 | 6 | 4 | 18.25 | 79.08 | 73.25 | 0.59 | 1.61 |
| CB-5 | 500 | 380 | 6 | 4 | 9.55 | 67.64 | 60.89 | 5.48 | −0.14 |

As can be seen from TABLE II, the catalyst composition used in Example CB-5, reduced from the calcined catalyst precursor fabricated in Example CA-5, which was calcined at 500° C. (the highest calcination temperature among all Examples CA-1 to CA-5) demonstrated a surprisingly high Methyl Gain of 5.48%, which is much higher than in any of Examples CB-1, CB-2, CB-3, and CB-4, at comparably high Ethyl Conversion and Propyls Conversion. Example CB-5 also exhibited a very low Ring Loss compared to Examples CB-1, CB-3, and CB-4. In addition, CB-5 exhibited the lowest TMB Conversion among all examples. The data clearly demonstrated the surprising benefit of calcining the precursor catalyst composition at a high temperature such as 500° C. to the alkyl-demethylation performance.

### Part D: Evaluating Impact of H₂/HC Molar Ratio on Catalyst Performance

In this Part D, a series of the calcined catalyst precursors fabricated in Part A above were reduced and evaluated for performance under varying alkyl-demethylation conditions, particularly varying H₂/HC molar ratios, in a manner substantially the same as described in Part B above. Calcined catalyst precursors, alkyl-demethylation conditions and performance data are included in TABLE III below.

Data in TABLE III show that increasing the H₂/HC molar ratio from 2 to 3 caused a significant increase in Methyl Gain and decrease of Ring Loss for a variety of alkyl-demethylation demethylation catalysts, while Ethyl Conversion and Propyls Conversion remained substantially the same. Furthermore, TMB Conversion was much lower across the board at higher H₂/HC ratio, which decreased the propensity of methyl group conversion and the increase in Methyl Gain.

Specifically, with respect to Examples D4-a and D4-b, where the catalyst composition comprises 1.0 wt % Rh, 0.5 wt % Au, and MG-30 support, upon adjusting the H₂/HC ratio from 2 to 3, the Methyl Gain increased from a loss of 3.03% at H₂/HC ratio of 2 to a net gain of 0.58% at H₂/HC ratio of 3, and Ring Loss decreased from 3.17% to 1.78%. Ethyl and Propyls Conversions remained substantially the same, however.

The catalyst compositions used in Examples CB-1, CB-2, CB-3, CB-4, and CB-5 listed in TABLE II above were also evaluated for alkyl-demethylation performances under a WHSV of 6 hour⁻¹ at various H₂/HC molar ratios in Examples D1-c to D1-o. The catalyst compositions, calcination temperature of the precursor catalyst compositions, the alkyl-demethylation conditions, and performance data are presented in TABLE IV below. As can be seen, at H₂/HC ratio of 4, the Methyl Gain reached a maximum level and Ring Loss a minimum level. Doubling the H₂/HC ratio to 8 did not result in substantial increase of Methyl Gain (Methyl Gain increased from 0.44% in Example D1-h to 0.66% in Example D1-1, e.g.), while Ring Loss increased from 1.99% in Example D1-h to 2.34% in Example D1-1. Similarly, the Ethyl Conversion and Propyl Conversion decreased with increasing H₂/HC ratio from 4 to 8, negating the small increase in Methyl Gain with a much lower decrease in Ethyl Conversion from 68.07% in Example D1-h to 63.15% in Example D1-1 after increasing H₂/HC ratio from 4 to 8.

TABLE III

| | | | | | | | | Performance | | | | |
|---|---|---|---|---|---|---|---|---|---|---|---|---|
| | Calcined Catalyst Precursor | | | Alkyl-demethylation Conditions | | | | Me | Et | Pr | TMB | Ring |
| Ex. | Ex. | | | Temp | Pres. | WHSV | H₂/HC | Gain | Conv. | Conv. | Conv. | Loss |
| No. | No. | Metal(s) | Support | (° C.) | (kPa-g) | (hr⁻¹) | Ratio | (%) | (%) | (%) | (%) | (%) |
| D1-a | A1 | 1% Rh | MG-30 | 360 | 689 | 4 | 2 | −6.66 | 70 | 56.12 | 24.72 | 5.51 |
| D1-b | A1 | 1% Rh | MG-30 | 360 | 689 | 4 | 3 | −1.87 | 64.46 | 51.83 | 16.69 | 3.42 |
| D2-a | A3 | 1.0% Rh; 0.5% Ag | MG-30 | 360 | 689 | 4 | 2 | 1.43 | 48.48 | 33.6 | 5.78 | 1.77 |
| D2-b | A3 | 1.0% Rh; 0.5% Ag | MG-30 | 360 | 689 | 4 | 3 | 3.78 | 44.15 | 33.24 | 1.87 | 0.95 |
| D3-a | A4 | 1.0% Rh; 0.25% Cu | MG-30 | 360 | 689 | 4 | 2 | 3.26 | 35.37 | 22.62 | 3.78 | −0.55 |
| D3-b | A4 | 1.0% Rh; 0.25% Cu | MG-30 | 360 | 689 | 4 | 3 | 3.38 | 32.99 | 20.51 | 2.57 | −0.79 |
| D4-a | A6 | 1.0% Rh; 0.5% Au | MG-30 | 360 | 689 | 4 | 2 | −3.81 | 64.55 | 51.29 | 19.61 | 3.96 |
| D4-b | A6 | 1.0% Rh; 0.5% Au | MG-30 | 360 | 689 | 4 | 3 | 0.27 | 60.73 | 49.83 | 13.48 | 1.47 |
| D5-a | A8 | 0.75% Rh; 0.25% Ir | MG-30 | 360 | 689 | 4 | 2 | −2.14 | 53.78 | 41.14 | 15.98 | 2.6 |
| D5-b | A8 | 0.75% Rh; 0.25% Ir | MG-30 | 360 | 689 | 4 | 3 | 3.04 | 48.07 | 37.96 | 5.83 | 0.81 |
| D6-a | A9 | 0.75% Rh; 0.25% Ru | MG-30 | 360 | 689 | 4 | 2 | −3.71 | 56.69 | 42.86 | 17.39 | 3.4 |
| D6-b | A9 | 0.75% Rh; 0.25% Ru | MG-30 | 360 | 689 | 4 | 3 | 1.14 | 51.3 | 39 | 7.86 | 1.3 |
| D7-a | A12 | 0.5% Rh | Al₂O₃ | 360 | 689 | 4 | 2 | −0.19 | 18.51 | 6.74 | 2.26 | −0.02 |
| D7-b | A12 | 0.5% Rh | Al₂O₃ | 360 | 689 | 4 | 3 | 0.93 | 18.15 | 8.08 | 0.71 | −0.26 |

TABLE IV

| | Cat Comp | | Alkyl-Demethylation | | | | TMB | Et | Pr | Me | Ring |
|---|---|---|---|---|---|---|---|---|---|---|---|
| Ex. | Of Ex. | Cal. Temp | Temp | Pressure | WHSV | H₂/HC | Conv. | Conv. | Conv. | Gain | Loss |
| No. | No. | (° C.) | (° C.) | (kPa-g) | (hr⁻¹) | Ratio | (%) | (%) | (%) | (%) | (%) |
| D1-c | CB-1 | 300 | 370 | 100 | 689 | 3 | 20.09 | 71.83 | 62.67 | −2.12 | 6.64 |
| D1-e | CB-3 | 400 | 370 | 100 | 689 | 3 | 11.97 | 67.44 | 55.86 | 2.72 | 0.77 |
| D1-f | CB-4 | 450 | 370 | 100 | 689 | 3 | 11.06 | 66.22 | 54.97 | 2.01 | 1.35 |
| D1-g | CB-5 | 500 | 370 | 100 | 689 | 3 | 9.22 | 57.13 | 47.41 | 2.79 | −0.40 |
| D1-h | CB-1 | 300 | 370 | 100 | 689 | 4 | 15.08 | 68.07 | 58.38 | 0.44 | 1.99 |
| D1-i | CB-3 | 400 | 370 | 100 | 689 | 4 | 10.93 | 64.79 | 54.76 | 2.89 | 0.86 |
| D1-j | CB-4 | 450 | 370 | 100 | 689 | 4 | 8.66 | 64.36 | 55.20 | 3.86 | 1.20 |
| D1-k | CB-5 | 500 | 370 | 100 | 689 | 4 | 8.66 | 58.34 | 47.46 | 4.18 | 0.60 |
| D1-l | CB-1 | 300 | 370 | 100 | 689 | 8 | 13.54 | 63.15 | 57.22 | 0.66 | 2.34 |
| D1-m | CB-3 | 400 | 370 | 100 | 689 | 8 | 9.16 | 60.04 | 54.07 | 2.95 | 1.22 |
| D1-n | CB-4 | 450 | 370 | 100 | 689 | 8 | 8.87 | 57.56 | 53.82 | 3.68 | 1.00 |
| D1-o | CB-5 | 500 | 370 | 100 | 689 | 8 | 5.60 | 54.78 | 47.60 | 4.48 | 0.19 |

### Section VII: Additional Aspects/Embodiments

The present disclosure further relates to the following non-limiting aspects and/or embodiments:

A1. A catalyst composition for selective alkyl-demethylation of a C2+-hydrocarbyl-substituted aromatic hydrocarbon, the catalyst composition comprising:
an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and combinations and mixtures of two or more thereof;
a first metal element M1 dispersed upon the oxide support material, wherein M1 is selected from Groups 7, 8, 9, and 10 elements, and combinations thereof; and
an optional second metal element M2 dispersed upon the oxide support material, wherein M2 is selected from groups 11, 12, 13, and 14 elements excluding A1, and combinations thereof, wherein M2 is present at least where M1 is a single metal element.

A2. The catalyst composition of A1, wherein the catalyst composition exhibits a hydrogen chemisorption value of at least 15%.

A3. The catalyst composition of A1 or A2, wherein M1 is selected from Ni, Re, Ru, Rh, Ir, and combinations thereof; preferably M1 is selected from Ru, Rh, Ir, and combinations thereof; more preferably M1 is selected from Ru, Rh, and combinations thereof; most preferably M1 is Rh.

A3a. The catalyst composition of any of A1 to A3, wherein M1 is a combination of at least two metal elements selected from Groups 7, 8, 9, and 10 elements, and M2 is absent.

A4. The catalyst composition of any of A1 to A3, wherein M1 is present substantially in elemental state.

A5. The catalyst composition of any of A1 to A4, wherein M2 is selected from Cu, Ag, Au, Zn, Ga, In, Ge, Sn, and combinations thereof; preferably M2 is selected from Cu, Ag, Au, Ga, and combinations thereof; more preferably M2 is selected from Cu, Ag, Au, and combinations thereof; most preferably M2 is Ag.

A6. The catalyst composition of any of A1 to A5, wherein M2 is present substantially in elemental state.

A7. The catalyst composition of any of A1 to A6, wherein the catalyst composition comprises M1 at a concentration from 0.01 to 10 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M1 on the basis of the total weight of the catalyst composition.

A8. The catalyst composition of any of A1 to A7, wherein the catalyst composition comprises M2 at a concentration from 0.01 to 5 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M2 on the basis of the total weight of the catalyst composition.

A9. The catalyst composition of any of A1 to A8, wherein the catalyst composition exhibits a molar ratio of M1 to M2 in a range from 0.1 to 10.

A10. The catalyst composition of any of A1 to A9, wherein the oxide support material is substantially free of a zeolite and discrete alumina.

All. The catalyst composition of any of A1 to A10, wherein the oxide support material is selected from the group consisting of CaO, MgO, SrO, silica, a composite oxide of MgO and Al₂O₃, and mixture and combinations thereof.

Al2. The catalyst composition of any of A1 to All, wherein the catalyst composition exhibits a hydrogen chemisorption value of at least 50%.

A13. The catalyst composition of any of A1 to Al2, wherein the oxide support material exhibits a BET surface area of at least 25 m²/g.

B1. A process for converting a C2+-hydrocarbyl-substituted aromatic hydrocarbon, the process comprising:
(A) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and
(B) contacting the C6+ aromatic hydrocarbon-containing feed with the catalyst composition of any of A1 to All in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute to obtain a first alkyl-demethylated effluent exiting the alkyl-demethylation zone.

B2. The process of Bl, wherein step (B) exhibits at least one of the following:
a positive methyl gain;
a C2+-alkyl group conversion in a range from 30% to 100%; and
an aromatic ring loss of no greater than 3%.

B3. The process of B1 or B2, wherein the C6+ aromatic hydrocarbon-containing feed comprises at least 80 wt % C8 aromatic hydrocarbons, and at least 5 wt % ethylbenzene based on a total weight of the C6+ aromatic hydrocarbon-containing feed.

B4. The process of B3 , wherein the alkyl-demethylation conditions comprise at least one of the following:
a presence of molecular hydrogen in the alkyl-demethylation zone at a partial pressure of hydrogen in a range from 50 to 2,500 (preferably from 100 to 1,700; preferably from 200 to 1,000) kilopascal absolute;
a temperature in a range from 180 to 500° C. (preferably from 200 to 480° C., preferably from 250 to 450° C., preferably from 350 to 400° C.);
an absolute total pressure in a range from 100 to 5,000 (preferably 200 to 4,000; preferably from 300 to 3,000; preferably from 350 to 2,500; preferably from 400 to 2,000; preferably 500 to 1,500) kilopascal;
a WHSV in a range from 0.1 to 20 hour' (preferably from 1 to 15 hour'; preferably from 2 to 12 hour', preferably from 3 to 10 hour', preferably from 4 to 8 hour'); and
a molar ratio of molecular hydrogen to the C6+ aromatic hydrocarbon-containing feed in a range from 0.1 to 10 (preferably from 0.5 to 10; preferably from 1 to 10; preferably from 1 to 8; preferably from 2 to 8; preferably from 2 to 5; and preferably from 2 to 4, preferably from 3 to 4).

B5. The process of B4, wherein the alkyl-demethylation conditions comprise a molar ratio of molecular hydrogen to the C6+ hydrocarbon-containing feed in a range from 1 to 8; preferably 2 to 8; more preferably 2 to 6; still more preferably 2 to 4; most preferably 3 to 4.

B6. The process of B4 or B5, wherein the C2+-hydrocarbyl-substituted aromatic hydrocarbons in the C6+ aromatic hydrocarbon-containing feed are present substantially in vapor phase in the alkyl-demethylation zone.

B7. The process of any of B3, B4, B5, and B6, wherein step (B) exhibits at least one of the following:
a xylene loss in a range from 0 to 15%;
an ethylbenzene conversion in a range from 30% to 100%;
a positive methyl gain; and
an aromatic ring loss no greater than 3%.

B8. The process of B1 or B2, wherein the C6+ aromatic hydrocarbon-containing feed comprises at least 80 wt % C9+ aromatic hydrocarbons, and at least 20 wt % C2+-hydrocarbyl-substituted C9+ aromatic hydrocarbons, based on a total weight of the C6+ aromatic hydrocarbon-containing feed.

B9. The process of B8, wherein the alkyl-demethylation conditions comprise at least one of the following:
a presence of molecular hydrogen in the alkyl-demethylation zone at a partial pressure of hydrogen in a range from 50 to 2,500 kilopascal absolute;
a temperature in a range from 180 to 500° C.;
an absolute total pressure in a range from 100 to 5,000 kilopascal;
a WHSV in a range from 0.1 to 20 hour⁻¹; and
a molar ratio of molecular hydrogen to the C6+ aromatic hydrocarbon-containing feed in a range from 0.1 to 10.

B10. The process of B9, wherein the alkyl-demethylation conditions comprise a molar ratio of molecular hydrogen to the C6+ hydrocarbon-containing feed in a range from 1 to 8; preferably 2 to 8; more preferably 2 to 6; still more preferably 2 to 4; most preferably 3 to 4.

B11. The process of any of B8, B9, and B10, wherein the C2+-hydrocarbyl-substituted aromatic hydrocarbons in the C6+ aromatic hydrocarbon-containing feed are present substantially in vapor phase in the alkyl-demethylation zone.

B12. The process of any of B8 to B11, wherein step (B) exhibits at least one of the following:
a trimethylbenzenes loss in a range from 0 to 20%;
a C2+-alkyl-substituted C9+ aromatic hydrocarbons conversion in a range from 30% to 100%;
a positive methyl gain; and
an aromatic ring loss no greater than 3%.

B13. The process of B12, wherein contacting further exhibits at least one of the following:
an ethyl group conversion from 30% to 100%; and
a C3-alkyl group conversion from 30% to 100%.

B14. The process of any of B1 to B13, wherein the alkyl-demethylation catalyst composition is prepared by the process of any of C1 to C22.

C1. A process for making a catalyst composition for alkyl-demethylation of a C2+-hydrocarbyl-substituted aromatic hydrocarbon, the process comprising:
(I) providing an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and mixtures and combinations of two or more thereof;
(II) providing a source material of a first metal element M1;
(III) dispersing the source material of the first metal element M1 on the oxide support material to obtain a catalyst composition precursor;
(IV) calcining the catalyst composition precursor at a temperature in a range from 250 to 650° C. (preferably from 350 to 550° C., more preferably from 400 to 500° C.) to obtain a calcined catalyst precursor; and
(V) contacting the calcined catalyst precursor with a reducing atmosphere under activating conditions to obtain the catalyst composition.

C2. The process of C1 or C2, wherein the oxide support material is substantially free of a zeolite and discrete alumina.

C3. The process of C1 or C2, wherein the oxide support comprises silica.

C4. The process of any of C1 to C3, wherein the source material of the first metal element M1 comprises a salt of the first metal element M1.

C5. The process of any of C1 to C4, wherein step (III) of dispersing the source material of the metal element M1 comprises:
(IIa) forming a first dispersion comprising the source material of the first metal element M1 and a first liquid dispersant;
(IIIb) contacting the oxide support material with the first dispersion of the source material of the first metal element M1 to obtain a mixture of the oxide support material and the source material; and
(IIIc) optionally drying the mixture of the oxide support material and the source material to form a dried mixture of the oxide support material and the source material.

C6. The process of any of C1 to C5, wherein the process further comprises, before step (IV), a step (IIa) below:
(IIa) providing a source material of a second metal element M2 differing from the first metal element M1, where M2 is selected from Groups 11, 12, 13, 14, and 15 excluding A1, and combinations thereof;
and step (III) comprises:
(IIId) forming a second dispersion comprising the source material of the second metal element M2 and a second liquid dispersant;
(IIIe) contacting the oxide support material with the second dispersion of the source material of the second t metal element M2 to obtain a mixture of the oxide support material and the source material of the second metal element M2; and the catalyst composition precursor comprises both the first metal element M1 and the second metal element M2.

C7. The process of C6, wherein the first liquid dispersant and the second liquid dispersant comprise the same material, and the first dispersion and the second dispersion are the same dispersion comprising both the source material of the first metal element M1 and the source material of the second metal M2.

C8. The process of C7, wherein the first liquid dispersant and/or the second liquid dispersant comprises water.

C9. The process of C7 or C8, wherein the liquid dispersion further comprises a linking agent comprising at least two functional groups capable of promoting (i) linkage between the source material of the first metal element M1 and the oxide support material and/or (ii) linkage between the source material of the first metal element M2 and the oxide support material.

C10. The process of C9, wherein the linking agent comprises an amino alcohol, an amino acid, a glycol, or a mixture or combination of two or more thereof.

C11. The process of any of C1 to C10, wherein after step (V) contacting the calcined catalyst precursor with a reducing atmosphere under activating conditions, the metal oxide support material exhibits an alpha value of no greater than 2.5, preferably no greater than 2.0, more preferably no greater than 1.5.

C12. The process of any of C1 to C11, wherein the first metal element M1 is present substantially in an elemental state after step (V) contacting the calcined catalyst precursor with the reducing atmosphere under activating conditions.

C13. The process of any of C1 to C12, wherein the first metal element M1 is selected from the group consisting of Groups 7, 8, 9 and 10 elements; preferably M1 is selected from Ni, Re, Ru, Rh, Ir, and combinations thereof; preferably M1 is selected from Ru, Rh, Ir, and combinations thereof; more preferably Mlis selected from Ru, Rh, and combinations thereof; most preferably M1 is Rh.

C14. The process of any of C1 to C13, wherein the catalyst composition comprises M1 at a concentration from 0.01 to 10 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M1 on the basis of the total weight of the catalyst composition.

C15. The process of any of C5 to C14, wherein M2 is selected from Cu, Ag, Au, Zn, Ga, In, Ge, Sn, and combinations thereof; preferably M2 is selected from Cu, Ag, Au, Ga, and combinations thereof; more preferably M2 is selected from Cu, Ag, Au, and combinations thereof; most preferably M2 is Ag.

C16. The process of any of C1 to C15, wherein the catalyst composition comprises M2 at a concentration from 0.01 to 5 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M2 on the basis of the total weight of the catalyst composition.

C17. The process of any of C1 to C16, wherein after contacting the calcined catalyst precursor with the reducing atmosphere under activating conditions, the catalyst composition exhibits a hydrogen chemisorption value of at least 15%, preferably at least 50%.

C18. The process of any of C1 to C17, wherein the activating conditions comprise at least one of the following:
a temperature in a range from 200 to 600° C. (preferably from 300 to 550° C.; preferably from 400 to 500° C.);
a hydrogen partial pressure in a range from 5 to 1000 (preferably 50 to 800, preferably 100 to 700, preferably 200 to 600, preferably 300 to 500) kilopascal absolute; and
a total pressure in a range from 100 to 1,000 (preferably 50 to 800, preferably 100 to 700, preferably 200 to 600, preferably 300 to 500) kilopascal absolute.

D1. A catalyst composition for alkyl-demethylation of a C2+-hydrocarbyl-substituted aromatic hydrocarbon prepared by the process of any of C1 to C18.

E1. A process for converting a C2+-hydrocarbyl-substituted aromatic hydrocarbon, the process comprising:
(1) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and
(2) contacting the C6+ aromatic hydrocarbon-containing feed with the catalyst composition of D1 in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute, optionally to obtain an alkyl-demethylated effluent exiting the alkyl-demethylation zone.

F1. The catalyst composition precursor prepared in the process of any of C1 to C18.

F2. The catalyst composition precursor of F1, comprising the oxide support material, the source material of the metal element M1, and the linking agent.

F3. The catalyst composition of F1 or F2, wherein the oxide support material comprises surface hydroxyl groups.

G. The calcined catalyst precursor prepared in the process of any of C1 to C18.

H1. A process for converting a C2+-hydrocarbyl-substituted aromatic hydrocarbon, the process comprising:
(i) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and
(ii) contacting the C6+ aromatic hydrocarbon-containing feed with an alkyl-demethylation catalyst composition in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute, optionally to obtain a first alkyl-demethylated effluent exiting the alkyl-demethylation zone;
wherein:
the alkyl-demethylation catalyst composition comprises an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and combinations and mixtures of two or more thereof;
   a first metal element M1 dispersed upon the oxide support material, wherein M1 is selected from Groups 7, 8, 9, and 10 elements, and combinations thereof; and
molecular hydrogen is fed into the alkyl-demethylation zone at a molar ratio to the C6+ aromatic hydrocarbon-containing feed in a range from 1 to 8; preferably 2 to 8; more preferably 2 to 6; still more preferably 2 to 4; most preferably 3 to 4.

H2. The process of H1, wherein M1 is selected from Ni, Re, Ru, Rh, Ir, and combinations thereof; preferably M1 is selected from Ru, Rh, Ir, and combinations thereof; more preferably M1 is selected from Ru, Rh, and combinations thereof; most preferably M1 is Rh.

H3. The process of H1 or H2, wherein M1 is present substantially in elemental state.

H4. The process of any of H1 to H3, wherein the alkyl-demethylation catalyst composition comprises M1 at a concentration from 0.01 to 10 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M1 on the basis of the total weight of the catalyst composition.

H5. The process of any of H1 to H4, wherein the alkyl-demethylation catalyst composition further comprises a second metal element M2 dispersed upon the oxide support material, where M2 is selected from Groups 11, 12, 13, 14, and 15 elements excluding A1, and combinations thereof.

H6. The process of H5, wherein M2 is selected from Cu, Ag, Au, Zn, Ga, In, Ge, Sn, and combinations thereof; preferably M2 is selected from Cu, Ag, Au, Ga, and combinations thereof; more preferably M2 is selected from Cu, Ag, Au, and combinations thereof; most preferably M2 is Ag.

H7. The process of H5 or H6, wherein the alkyl-demethylation catalyst composition comprises M2 at a concentration from 0.01 to 5 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M2 on the basis of the total weight of the catalyst composition.

H8. The process of any of H5 to H7, wherein the alkyl-demethylation catalyst composition exhibits a molar ratio of M1 to M2 in a range from 0.1 to 10.

H9. The process of any of H1 to H8, wherein the oxide support material is substantially free of a zeolite and discrete alumina.

H10. The process of any of H1 to H9, wherein the oxide support material is selected from the group consisting of CaO, MgO, SrO, silica, a composite oxide of MgO and Al₂O₃, and mixture and combinations thereof.

H11. The process of any of H1 to H8, wherein the catalyst composition exhibits a hydrogen chemisorption value of at least 15%, preferably at least 50%.

H12. The process of any of H1 to H11, wherein the oxide support material exhibits a BET surface area of at least 25 m²/g.

H13. The process of any of H1 to H12, wherein the alkyl-demethylation conditions comprise at least one of the following:
a presence of molecular hydrogen in the alkyl-demethylation zone at a partial pressure of hydrogen in a range from 50 to 2,500 (preferably from 100 to 1,700; preferably from 200 to 1,000) kilopascal absolute;
a temperature in a range from 180 to 500° C. (preferably from 200 to 480° C., preferably from 250 to 450° C., preferably from 350 to 400° C.);
an absolute total pressure in a range from 100 to 5,000 (preferably 200 to 4,000; preferably from 300 to 3,000; preferably from 350 to 2,500; preferably from 400 to 2,000; preferably 500 to 1,500) kilopascal; and
a WHSV in a range from 0.1 to 20 hour⁻¹⁻ (preferably from 1 to 15 hour⁻¹; preferably from 2 to 12 hour⁻¹, preferably from 3 to 10 hour⁻¹, preferably from 4 to 8 hour⁻¹).

H14. The process of any of H1 to H13, wherein the contacting step (ii) exhibits at least one of the following:
a positive methyl gain;
a C2+-alkyl group conversion in a range from 30% to 100%; and an aromatic ring loss of no greater than 3%.

H15. The process of any of H1 to H14, wherein the alkyl-demethylation catalyst composition is the catalyst composition prepared in any of C1 to C18.

1. A catalyst composition for selective alkyl-demethylation of a C2+-hydrocarbyl-substituted aromatic hydrocarbon, the catalyst composition comprising:
an oxide support material selected from the group consisting of an alkaline earth metal oxide, silica, a composite of an alkaline earth metal oxide and Al₂O₃, a composite of ZnO and Al₂O₃, a lanthanide oxide, a composite of a lanthanide oxide and Al₂O₃, and combinations and mixtures of two or more thereof;
a first metal element M1 dispersed upon the oxide support material, wherein M1 is selected from Groups 7, 8, 9, and 10 elements, and combinations thereof; and
an optional second metal element M2 dispersed upon the oxide support material, wherein M2 is selected from groups 11, 12, 13, and 14 elements excluding A1, and combinations thereof, wherein M2 is present at least where M1 is a single metal element.

2. The catalyst composition of claim 1, wherein the catalyst composition exhibits a hydrogen chemisorption value of at least 15%.

3. The catalyst composition of claim 1, wherein M1 is selected from Ni, Re, Ru, Rh, Ir, and combinations thereof; preferably M1 is selected from Ru, Rh, Ir, and combinations thereof; more preferably M1 is selected from Ru, Rh, and combinations thereof; most preferably M1 is Rh.

4. The catalyst composition of claim 1, wherein M1 is a combination of at least two metal elements selected from Groups 7, 8, 9, and 10 elements, and M2 is absent.

5. The catalyst composition of claim 1, wherein M1 is present substantially in elemental state.

6. The catalyst composition of claim 1, wherein M2 is selected from Cu, Ag, Au, Zn, Ga, In, Ge, Sn, and combinations thereof; preferably M2 is selected from Cu, Ag, Au, Ga, and combinations thereof; more preferably M2 is selected from Cu, Ag, Au, and combinations thereof; most preferably M2 is Ag.

7. The catalyst composition of claim 1, wherein M2 is present substantially in elemental state.

8. The catalyst composition of claim 1, wherein the catalyst composition comprises M1 at a concentration from 0.01 to 10 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M1 on the basis of the total weight of the catalyst composition.

9. The catalyst composition of claim 1, wherein the catalyst composition comprises M2 at a concentration from 0.01 to 5 wt % (preferably from 0.1 to 5 wt %; more preferably from 0.2 to 3 wt %, still more preferably from 0.4 to 2 wt %, still more preferably from 0.5 to 1.5 wt %), expressed as weight percentage of M2 on the basis of the total weight of the catalyst composition.

10. The catalyst composition of claim 1, wherein the oxide support material is substantially free of a zeolite and discrete alumina.

11. The catalyst composition of claim 1, wherein the oxide support material is selected from the group consisting of CaO, MgO, SrO, silica, a composite oxide of MgO and Al₂O₃, and mixture and combinations thereof.

12. The catalyst composition of claim 1, wherein the catalyst composition exhibits a hydrogen chemisorption value of at least 50%.

13. The catalyst composition of claim 1, wherein the oxide support material exhibits a BET surface area of at least 25 m²/g.

14. A process for converting a C2+-hydrocarbyl-substituted aromatic hydrocarbon, the process comprising:
(A) providing a C6+ aromatic hydrocarbon-containing feed comprising the C2+-hydrocarbyl-substituted aromatic hydrocarbon, wherein the C2+-hydrocarbyl-substituted aromatic hydrocarbon has (i) a C2+ alkyl substitute attached to an aromatic ring therein and/or (ii) an aliphatic ring annelated to an aromatic ring therein; and
(B) contacting the C6+ aromatic hydrocarbon-containing feed with the catalyst composition of any of the preceding claims in an alkyl-demethylation zone under alkyl-demethylation conditions effective to convert at least a portion of the C2+-hydrocarbyl-substituted aromatic hydrocarbon to an alkyl-demethylated aromatic hydrocarbon comprising at least one methyl substitute to obtain a first alkyl-demethylated effluent exiting the alkyl-demethylation zone.

15. The process of claim 14, wherein step (B) exhibits at least one of the following:
a positive methyl gain;
a C2+-alkyl group conversion in a range from 30% to 100%; and
an aromatic ring loss of no greater than 3%.

16. The process of claim 14, wherein the C6+ aromatic hydrocarbon-containing feed comprises at least 80 wt % C8 aromatic hydrocarbons, and at least 5 wt % ethylbenzene.

17. The process of claim 16, wherein step (B) exhibits at least one of the following:
a xylene loss in a range from 0 to 15%;
an ethylbenzene conversion in a range from 30% to 100%;
a positive methyl gain; and
an aromatic ring loss no greater than 3%.

18. The process of B1 or B2 claim 17, wherein the C6+ aromatic hydrocarbon-containing feed comprises at least 80 wt % C9+ aromatic hydrocarbons, and at least 20 wt % C2+-hydrocarbyl-substituted C9+ aromatic hydrocarbons, based on a total weight of the C6+ aromatic hydrocarbon-containing feed.

19. The process of claim 18, wherein step (B) exhibits at least one of the following:
a trimethylbenzenes loss in a range from 0 to 20%;
a C2+-alkyl-substituted C9+ aromatic hydrocarbons conversion in a range from 30% to 100%;
a positive methyl gain; and
an aromatic ring loss no greater than 3%.

20. The process of claim 18, wherein contacting further exhibits at least one of the following:
an ethyl group conversion from 30% to 100%; and
a C3-alkyl group conversion from 30% to 100%.

21. The process of claim 14, wherein the alkyl-demethylation conditions comprise at least one of the following:
a presence of molecular hydrogen in the alkyl-demethylation zone at a partial pressure of hydrogen in a range from 50 to 2,500 kilopascal absolute;
a temperature in a range from 180 to 500° C.;
an absolute total pressure in a range from 100 to 5,000 kilopascal;
a WHSV in a range from 0.1 to 20 hour−1; and
a molar ratio of molecular hydrogen to the C6+ aromatic hydrocarbon-containing feed in a range from 0.1 to 10.

22. The process of claim 14, wherein the alkyl-demethylation conditions comprise a molar ratio of molecular hydrogen to the C6+ hydrocarbon-containing feed in a range from 1 to 8; preferably 2 to 8; more preferably 2 to 6; still more preferably 2 to 4; most preferably 3 to 4.

23. The process of any of claims 14 to 22 claim 14, wherein the C2+-hydrocarbyl-substituted aromatic hydrocarbons in the C6+ aromatic hydrocarbon-containing feed are present substantially in vapor phase in the alkyl-demethylation zone.
